(19) United States
(12) Patent Application Publication
(10) Pub. No.: US 2025/0106623 A1
(43) Pub. Date: Mar. 27, 2025

(54) BROADCAST COMMUNICATIONS FOR TERRESTRIAL AND NON-TERRESTRIAL CELLS

(71) Applicant: QUALCOMM Incorporated, San Diego, CA (US)

(72) Inventors: Bharat SHRESTHA, San Diego, CA (US); Prasad Reddy KADIRI, San Diego, CA (US); Umesh PHUYAL, San Diego, CA (US); Haris ZISIMOPOULOS, London (GB); Soo Bum LEE, San Diego, CA (US); Mungal Singh DHANDA, Slough (GB); Miguel GRIOT, La Jolla, CA (US)

(21) Appl. No.: 18/730,752

(22) PCT Filed: Jan. 5, 2023
(86) PCT No.: PCT/US2023/060173

§ 371 Date: Jul. 19, 2024

(30) Foreign Application Priority Data
Mar. 9, 2022 (GR) 20220100221

(51) Int. Cl. H04W 12/037; H04W 12/041; H04W 72/30

(52) U.S. Cl. CPC H04W 12/037; H04W 12/041; H04W 72/30

(57) ABSTRACT

Methods, systems, and devices for wireless communication are described. A user equipment (UE) may receive a control message indicating one or more decryption keys for multicast and broadcast service (MBS) communications within a geographic service area supported by one or more cells of a non-terrestrial network (NTN) or a terrestrial network (TN). The UE may also receive geographic information associated with the geographic coverage area, synchronization information associated with the one or more cells, prioritization information associated with the one or more cells, or a combination thereof. Accordingly, the UE may receive an MBS message via the one or more cells, and may decrypt the MBS message based on the control message, the geographic information, the synchronization information, the prioritization information, or a combination thereof. The techniques described herein may enable the UE to receive encrypted MBS communications within the geographic service area.

### CROSS REFERENCES

The present application for patent is a 371 national stage filing of International PCT Application No. PCT/US2023/060173 by SHRESTHA et al., entitled “BROADCAST COMMUNICATIONS FOR TERRESTRIAL AND NON-TERRESTRIAL CELLS,” filed Jan. 5, 2023; and claims priority to claims priority to Greek patent application No. 20220100221 by SHRESTHA et al., entitled “BROADCAST COMMUNICATIONS FOR TERRESTRIAL AND NON-TERRESTRIAL CELLS,” filed Mar. 9, 2022, each of which is assigned to the assignee hereof, and each of which is expressly incorporated by reference in its entirety herein.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

A method for wireless communications at a UE is described. The method may include receiving a control message that indicates one or more decryption keys for multicast and broadcast service (MBS) communications within a geographic service area supported by a cell. The method may further include receiving, via the cell, an MBS message within the geographic service area supported by the cell. The method may further include decrypting the MBS message using the one or more decryption keys indicated by the control message.

An apparatus for wireless communications at a UE is described. The apparatus may include a processor and memory coupled with the processor, where the processor is configured to receive a control message that indicates one or more decryption keys for MBS communications within a geographic service area supported by a cell. The processor may be further configured to receive, via the cell, an MBS message within the geographic service area supported by the cell. The processor may be further configured to decrypt the MBS message using the one or more decryption keys indicated by the control message.

Another apparatus for wireless communications at a UE is described. The apparatus may include means for receiving a control message that indicates one or more decryption keys for MBS communications within a geographic service area supported by a cell. The apparatus may further include means for receiving, via the cell, an MBS message within the geographic service area supported by the cell. The apparatus may further include means for decrypting the MBS message using the one or more decryption keys indicated by the control message.

A non-transitory computer-readable medium storing code for wireless communications at a UE is described. The code may include instructions executable by a processor to receive a control message that indicates one or more decryption keys for MBS communications within a geographic service area supported by a cell. The instructions may be further executable by the processor to receive, via the cell, an MBS message within the geographic service area supported by the cell, and decrypt the MBS message using the one or more decryption keys indicated by the control message.

Some examples of the method, apparatuses, and non-transitory computer-readable medium described herein may further include operations, features, means, or instructions for receiving an indication of multiple decryption keys for multiple geographic service areas supported by the cell. Some examples of the method, apparatuses, and non-transitory computer-readable medium described herein may further include operations, features, means, or instructions for selecting the one or more decryption keys from the multiple decryption keys based on the geographic service area.

In some examples of the method, apparatuses, and non-transitory computer-readable medium described herein, the multiple decryption keys may include time-variant decryption keys that are based on a geographic location of the cell.

Some examples of the method, apparatuses, and non-transitory computer-readable medium described herein may further include operations, features, means, or instructions for generating the one or more decryption keys based on an identifier of the cell, an index associated with a geographic location of the UE, a beam index, a tracking area, a key value, a counter value, or a combination thereof.

Some examples of the method, apparatuses, and non-transitory computer-readable medium described herein may further include operations, features, means, or instructions for transmitting an indication of a geographic location of the UE, where receiving the control message is based on the geographic location of the UE corresponding to the geographic service area supported by the cell.

In some examples of the method, apparatuses, and non-transitory computer-readable medium described herein, the MBS message may include multicast control data, multicast traffic data, or both.

In some examples of the method, apparatuses, and non-transitory computer-readable medium described herein, the multicast control data includes an indication that the multicast traffic data is encrypted, an indication that an encryption key used for encryption of the multicast traffic data has changed within a time period, an indication of an index associated with the encryption key used for encryption of the multicast traffic data, or a combination thereof.

Some examples of the method, apparatuses, and non-transitory computer-readable medium described herein may further include operations, features, means, or instructions for receiving the MBS message based on an encryption status of the multicast traffic data and on a determination that the one or more decryption keys are valid for the MBS message.

Some examples of the method, apparatuses, and non-transitory computer-readable medium described herein may further include operations, features, means, or instructions for receiving a paging message that indicates an encryption key used for encryption of the multicast traffic data has changed.

Some examples of the method, apparatuses, and non-transitory computer-readable medium described herein may further include operations, features, means, or instructions for determining that the UE has moved to a second geographic service area that is different from the geographic service area supported by the cell. Some examples of the method, apparatuses, and non-transitory computer-readable medium described herein may further include operations, features, means, or instructions for decrypting the multicast traffic data using a decryption key that is based on a tracking area associated with the second geographic service area, an index associated with the second geographic service area, or both.

A method for wireless communications at a UE is described. The method may include receiving an indication of a configuration for a geographic service area supported by a cell. In some examples, the geographic service area may be associated with MBS communications, and the configuration may include geographic information associated with the geographic service area. The method may further include receiving an MBS message within the geographic service area supported by the cell based on the geographic information in the configuration.

An apparatus for wireless communications at a UE is described. The apparatus may include a processor and memory coupled with the processor, where the processor is configured to receive an indication of a configuration for a geographic service area supported by a cell. In some examples, the geographic service area may be associated with MBS communications, and the configuration may include geographic information associated with the geographic service area. The processor may be further configured to receive an MBS message within the geographic service area supported by the cell based on the geographic information in the configuration.

Another apparatus for wireless communications at a UE is described. The apparatus may include means for receiving an indication of a configuration for a geographic service area supported by a cell. In some examples, the geographic service area may be associated with MBS communications, and the configuration may include geographic information associated with the geographic service area. The apparatus may further include means for receiving an MBS message within the geographic service area supported by the cell based on the geographic information in the configuration.

A non-transitory computer-readable medium storing code for wireless communications at a UE is described. The code may include instructions executable by a processor to receive an indication of a configuration for a geographic service area supported by a cell. In some examples, the geographic service area may be associated with MBS communications, and the configuration may include geographic information associated with the geographic service area. The instructions may be further executable by the processor to receive an MBS message within the geographic service area supported by the cell based on the geographic information in the configuration.

Some examples of the method, apparatuses, and non-transitory computer-readable medium described herein may further include operations, features, means, or instructions for decrypting the MBS message using a decryption key that is based on the configuration for the geographic service area.

In some examples of the method, apparatuses, and non-transitory computer-readable medium described herein, receiving the indication may include operations, features, means, or instructions for receiving dedicated signaling or a broadcast message that indicates one or more tracking areas, cell identifiers, or frequencies associated with the geographic service area.

Some examples of the method, apparatuses, and non-transitory computer-readable medium described herein may further include operations, features, means, or instructions for receiving a message that indicates an association between multiple tracking area codes (TACs) and multiple tracking areas within the geographic service area supported by the cell. Some examples of the method, apparatuses, and non-transitory computer-readable medium described herein may further include operations, features, means, or instructions for performing a cell selection procedure based on the association, a tracking area of the UE, a set of cells corresponding to the tracking area of the UE, a set of frequencies corresponding to the tracking area of the UE, or a combination thereof.

In some examples of the method, apparatuses, and non-transitory computer-readable medium described herein, receiving the indication may include operations, features, means, or instructions for receiving a message that indicates a time duration for which the configuration of the geographic service area is valid, where the configuration includes a list of frequencies or cells associated with the geographic service area.

Some examples of the method, apparatuses, and non-transitory computer-readable medium described herein may further include operations, features, means, or instructions for performing a cell selection procedure based on a tracking area of the UE, the configuration for the geographic service area, and a time duration for which the configuration is valid.

In some examples of the method, apparatuses, and non-transitory computer-readable medium described herein, receiving the indication may include operations, features, means, or instructions for receiving, via a serving cell of the UE or a previous serving cell of the UE, a broadcast message that indicates a list of tracking areas associated with the geographic service area.

Some examples of the method, apparatuses, and non-transitory computer-readable medium described herein may further include operations, features, means, or instructions for receiving a non-access spectrum (NAS) message or a radio resource control (RRC) message that indicates geo-fencing information associated with the geographic service area supported by the cell. Some examples of the method, apparatuses, and non-transitory computer-readable medium described herein may further include operations, features, means, or instructions for performing a cell selection procedure based on the geo-fencing information, the configuration of the geographic service area, or both.

A method for wireless communications at a UE is described. The method may include receiving an indication of synchronization information associated with a first cell and a second cell, where the first cell and the second cell each support MBS communications within a geographic service area. The method may further include receiving one or more MBS messages within the geographic service area supported by the first cell and the second cell based on the synchronization information.

An apparatus for wireless communications at a UE is described. The apparatus may include a processor and memory coupled with the processor, where the processor is configured to receive an indication of synchronization information associated with a first cell and a second cell. In some examples, the first cell and the second cell may each support MBS communications within a geographic service area. The processor may be further configured to receive one or more MBS messages within the geographic service area supported by the first cell and the second cell based on the synchronization information.

Another apparatus for wireless communications at a UE is described. The apparatus may include means for receiving an indication of synchronization information associated with a first cell and a second cell, where the first cell and the second cell each support MBS communications within a geographic service area. The apparatus may further include means for receiving one or more MBS messages within the geographic service area supported by the first cell and the second cell based on the synchronization information.

A non-transitory computer-readable medium storing code for wireless communications at a UE is described. The code may include instructions executable by a processor to receive an indication of synchronization information associated with a first cell and a second cell, where the first cell and the second cell each support MBS communications within a geographic service area. The instructions may be further executable by the processor to receive one or more MBS messages within the geographic service area supported by the first cell and the second cell based on the synchronization information.

Some examples of the method, apparatuses, and non-transitory computer-readable medium described herein may further include operations, features, means, or instructions for decoding the one or more MBS messages based on the synchronization information.

In some examples of the method, apparatuses, and non-transitory computer-readable medium described herein, receiving the one or more MBS messages may include operations, features, means, or instructions for receiving the one or more MBS messages via one or both of the first cell or the second cell based on a signal quality associated with the first cell, a signal quality associated with the second cell, or both.

In some examples of the method, apparatuses, and non-transitory computer-readable medium described herein, receiving the one or more MBS messages may include operations, features, means, or instructions for receiving the one or more MBS messages via one or both of the first cell or the second cell while the UE is in a receive-only mode.

In some examples of the method, apparatuses, and non-transitory computer-readable medium described herein, receiving the one or more MBS messages may include operations, features, means, or instructions for receiving the one or more MBS messages via one or both of the first cell or the second cell based on the first cell or the second cell applying a delay offset to the one or more MBS messages.

Some examples of the method, apparatuses, and non-transitory computer-readable medium described herein may further include operations, features, means, or instructions for receiving a message that indicates the delay offset. Some examples of the method, apparatuses, and non-transitory computer-readable medium described herein may further include operations, features, means, or instructions for decoding at least a portion of the one or more MBS messages based on the delay offset, where one or both of the first cell or the second cell are associated with a non-terrestrial network or a terrestrial network.

A method for wireless communications at a UE is described. The method may include receiving an indication of prioritization information associated with a first cell and a second cell, where the prioritization information indicates one or more parameters for prioritization of the first cell or the second cell for MBS communications within a geographic service area. The method may further include receiving, via the first cell and in accordance with the prioritization information, an MBS message within the geographic service area supported by the first cell and the second cell.

An apparatus for wireless communications at a UE is described. The apparatus may include a processor and memory coupled with the processor, where the processor is configured to receive an indication of prioritization information associated with a first cell and a second cell. In some examples, the prioritization information may indicate one or more parameters for prioritization of the first cell or the second cell for MBS communications within a geographic service area. The processor may be further configured to receive, via the first cell and in accordance with the prioritization information, an MBS message within the geographic service area supported by the first cell and the second cell.

Another apparatus for wireless communications at a UE is described. The apparatus may include means for receiving an indication of prioritization information associated with a first cell and a second cell, where the prioritization information indicates one or more parameters for prioritization of the first cell or the second cell for MBS communications within a geographic service area. The apparatus may further include means for receiving, via the first cell and in accordance with the prioritization information, an MBS message within the geographic service area supported by the first cell and the second cell.

A non-transitory computer-readable medium storing code for wireless communications at a UE is described. The code may include instructions executable by a processor to receive an indication of prioritization information associated with a first cell and a second cell, where the prioritization information indicates one or more parameters for prioritization of the first cell or the second cell for MBS communications within a geographic service area. The instructions may be further executable by the processor to receive, via the first cell and in accordance with the prioritization information, an MBS message within the geographic service area supported by the first cell and the second cell.

Some examples of the method, apparatuses, and non-transitory computer-readable medium described herein may further include operations, features, means, or instructions for decrypting the MBS message using a decryption key that corresponds to the first cell.

In some examples of the method, apparatuses, and non-transitory computer-readable medium described herein, receiving the MBS message may include operations, features, means, or instructions for receiving a first portion of the MBS message via the first cell. In some examples of the method, apparatuses, and non-transitory computer-readable medium described herein, receiving the MBS message may further include operations, features, means, or instructions for determining to prioritize the first cell for reception of a remaining portion of the MBS message.

Some examples of the method, apparatuses, and non-transitory computer-readable medium described herein may further include operations, features, means, or instructions for receiving a multicast control message that indicates a set of cells that support the geographic service area and a network type associated with the set of cells. Some examples of the method, apparatuses, and non-transitory computer-readable medium described herein may further include operations, features, means, or instructions for determining to prioritize the first cell for reception of the MBS message based on the prioritization information, information in the multicast control message including geographic area and network type, or both.

Some examples of the method, apparatuses, and non-transitory computer-readable medium described herein may further include operations, features, means, or instructions for receiving a multicast control message that indicates an association between one or more decryption keys and one or more cells or frequencies associated with the geographic service area, a time duration for which the association may be valid, or both. Some examples of the method, apparatuses, and non-transitory computer-readable medium described herein may further include operations, features, means, or instructions for determining to prioritize the first cell or the second cell for reception of MBS communications based on the multicast control message, a capability of the UE to decode MBS communications within the geographic service area, or both.

In some examples of the method, apparatuses, and non-transitory computer-readable medium described herein, the first cell may be associated with a non-terrestrial network and the second cell may be associated with a terrestrial network.

A method for wireless communications at a network entity is described. The method may include outputting a control message that indicates one or more decryption keys for MBS communications within a geographic service area supported by a cell. The method may further include encrypting an MBS message using an encryption key that corresponds to the one or more decryption keys indicated by the control message. The method may further include outputting, via the cell, the MBS message within the geographic service area supported by the cell.

An apparatus for wireless communications at a network entity is described. The apparatus may include a processor and memory coupled with the processor, where the processor is configured to output a control message that indicates one or more decryption keys for MBS communications within a geographic service area supported by a cell. The processor may be further configured to encrypt an MBS message using an encryption key that corresponds to the one or more decryption keys indicated by the control message. The processor may be further configured to output, via the cell, the MBS message within the geographic service area supported by the cell.

Another apparatus for wireless communications at a network entity is described. The apparatus may include means for outputting a control message that indicates one or more decryption keys for MBS communications within a geographic service area supported by a cell. The apparatus may further include means for encrypting an MBS message using an encryption key that corresponds to the one or more decryption keys indicated by the control message. The apparatus may further include means for outputting, via the cell, the MBS message within the geographic service area supported by the cell.

A non-transitory computer-readable medium storing code for wireless communications at a network entity is described. The code may include instructions executable by a processor to output a control message that indicates one or more decryption keys for MBS communications within a geographic service area supported by a cell. The instructions may be further executable by the processor to encrypt an MBS message using an encryption key that corresponds to the one or more decryption keys indicated by the control message. The instructions may be further executable by the processor to output, via the cell, the MBS message within the geographic service area supported by the cell.

Some examples of the method, apparatuses, and non-transitory computer-readable medium described herein may further include operations, features, means, or instructions for outputting an indication of multiple decryption keys for multiple geographic service areas supported by the cell, where the multiple decryption keys include the one or more decryption keys indicated by the control message.

In some examples of the method, apparatuses, and non-transitory computer-readable medium described herein, the multiple decryption keys may include time-variant decryption keys that are based on a geographic location of the cell.

Some examples of the method, apparatuses, and non-transitory computer-readable medium described herein may further include operations, features, means, or instructions for generating the one or more decryption keys based on an identifier of the cell, an index associated with a geographic location, a beam index, a tracking area, a key value, a counter value, or a combination thereof.

Some examples of the method, apparatuses, and non-transitory computer-readable medium described herein may further include operations, features, means, or instructions for obtaining a first message that indicates a geographic location of a UE. Some examples of the method, apparatuses, and non-transitory computer-readable medium described herein may further include operations, features, means, or instructions for outputting a second message that indicates the one or more decryption keys are applicable to the geographic location of the UE.

In some examples of the method, apparatuses, and non-transitory computer-readable medium described herein, the MBS message may include multicast control data, multicast traffic data, or both.

In some examples of the method, apparatuses, and non-transitory computer-readable medium described herein, the multicast control data may indicate that the multicast traffic data is encrypted.

In some examples of the method, apparatuses, and non-transitory computer-readable medium described herein, the multicast control data may indicate that the encryption key used for encryption of the multicast traffic data has changed within a time period.

Some examples of the method, apparatuses, and non-transitory computer-readable medium described herein may further include operations, features, means, or instructions for outputting a paging message that indicates the encryption key used for encryption of the multicast traffic data has changed.

In some examples of the method, apparatuses, and non-transitory computer-readable medium described herein, the multicast control data may indicate an index associated with the encryption key used for encryption of the multicast traffic data.

In some examples of the method, apparatuses, and non-transitory computer-readable medium described herein, the one or more decryption keys may correspond to a tracking area associated with the geographic service area, an index associated with the geographic service area, or both.

A method for wireless communications at a network entity is described. The method may include outputting an indication of a configuration for a geographic service area supported by a cell. In some examples, the geographic service area may be associated with MBS communications, and the configuration may include geographic information associated with the geographic service area. The method may further include outputting an MBS message within the geographic service area supported by the cell based on the geographic information in the configuration.

An apparatus for wireless communications at a network entity is described. The apparatus may include a processor and memory coupled with the processor, where the processor is configured to output an indication of a configuration for a geographic service area supported by a cell. In some examples, the geographic service area may be associated with MBS communications, and the configuration may include geographic information associated with the geographic service area. The processor may be further configured to output an MBS message within the geographic service area supported by the cell based on the geographic information in the configuration.

Another apparatus for wireless communications at a network entity is described. The apparatus may include means for outputting an indication of a configuration for a geographic service area supported by a cell. In some examples, the geographic service area may be associated with MBS communications, and the configuration may include geographic information associated with the geographic service area. The apparatus may further include means for outputting an MBS message within the geographic service area supported by the cell based on the geographic information in the configuration.

A non-transitory computer-readable medium storing code for wireless communications at a network entity is described. The code may include instructions executable by a processor to output an indication of a configuration for a geographic service area supported by a cell. In some examples, the geographic service area may be associated with MBS communications, and the configuration may include geographic information associated with the geographic service area. The instructions may be further executable by the processor to output an MBS message within the geographic service area supported by the cell based on the geographic information in the configuration.

Some examples of the method, apparatuses, and non-transitory computer-readable medium described herein may further include operations, features, means, or instructions for encrypting the MBS message based on an encryption key that corresponds to the configuration for the geographic service area.

In some examples of the method, apparatuses, and non-transitory computer-readable medium described herein, outputting the indication may include operations, features, means, or instructions for outputting dedicated signaling or a broadcast message that indicates one or more tracking areas, cell identifiers, or frequencies associated with the geographic service area.

In some examples of the method, apparatuses, and non-transitory computer-readable medium described herein, outputting the indication may include operations, features, means, or instructions for outputting a message that indicates an association between multiple TACs and multiple tracking areas within the geographic service area supported by the cell.

In some examples of the method, apparatuses, and non-transitory computer-readable medium described herein, outputting the indication may include operations, features, means, or instructions for outputting a message that indicates a time duration for which the configuration of the geographic service area is valid, where the configuration includes a list of frequencies or cells associated with the geographic service area.

In some examples of the method, apparatuses, and non-transitory computer-readable medium described herein, outputting the indication may include operations, features, means, or instructions for outputting a broadcast message that indicates a list of tracking areas associated with the geographic service area.

Some examples of the method, apparatuses, and non-transitory computer-readable medium described herein may further include operations, features, means, or instructions for outputting a NAS message or an RRC message that indicates geo-fencing information associated with the geographic service area supported by the cell.

A method for wireless communications at a network entity is described. The method may include outputting an indication of synchronization information associated with a first cell and a second cell, where the first cell and the second cell each support MBS communications within a geographic service area. The method may further include outputting one or more MBS messages within the geographic service area supported by the first cell and the second cell based on the synchronization information.

An apparatus for wireless communications at a network entity is described. The apparatus may include a processor and memory coupled with the processor, where the processor is configured to output an indication of synchronization information associated with a first cell and a second cell. In some examples, the first cell and the second cell may each support MBS communications within a geographic service area. The processor may be further configured to output one or more MBS messages within the geographic service area supported by the first cell and the second cell based on the synchronization information.

Another apparatus for wireless communications at a network entity is described. The apparatus may include means for outputting an indication of synchronization information associated with a first cell and a second cell, where the first cell and the second cell each support MBS communications within a geographic service area. The apparatus may further include means for outputting one or more MBS messages within the geographic service area supported by the first cell and the second cell based on the synchronization information.

A non-transitory computer-readable medium storing code for wireless communications at a network entity is described. The code may include instructions executable by a processor to output an indication of synchronization information associated with a first cell and a second cell, where the first cell and the second cell each support MBS communications within a geographic service area. The instructions may be further executable by the processor to output one or more MBS messages within the geographic service area supported by the first cell and the second cell based on the synchronization information.

Some examples of the method, apparatuses, and non-transitory computer-readable medium described herein may further include operations, features, means, or instructions for encrypting the one or more MBS messages based on an encryption key associated with the first cell, the second cell, the geographic service area, or a combination thereof.

In some examples of the method, apparatuses, and non-transitory computer-readable medium described herein, outputting the one or more MBS messages may include operations, features, means, or instructions for outputting the one or more MBS messages with a delay offset that corresponds to a propagation delay between the first cell and the second cell.

Some examples of the method, apparatuses, and non-transitory computer-readable medium described herein may further include operations, features, means, or instructions for outputting a message that indicates the delay offset prior to transmission of the one or more MBS messages.

A method for wireless communications at a network entity is described. The method may include outputting an indication of prioritization information associated with a first cell and a second cell. In some examples, the prioritization information indicates one or more parameters for prioritization of the first cell or the second cell for MBS communications within a geographic service area. The method may further include outputting, via the first cell, an MBS message within the geographic service area supported by the first cell and the second cell.

An apparatus for wireless communications at a network entity is described. The apparatus may include a processor and memory coupled with the processor, where the processor is configured to output an indication of prioritization information associated with a first cell and a second cell. In some examples, the prioritization information may indicate one or more parameters for prioritization of the first cell or the second cell for MBS communications within a geographic service area. The processor may be further configured to output, via the first cell, an MBS message within the geographic service area supported by the first cell and the second cell.

Another apparatus for wireless communications at a network entity is described. The apparatus may include means for outputting an indication of prioritization information associated with a first cell and a second cell. In some examples, the prioritization information may indicate one or more parameters for prioritization of the first cell or the second cell for MBS communications within a geographic service area. The apparatus may further include means for outputting, via the first cell, an MBS message within the geographic service area supported by the first cell and the second cell.

A non-transitory computer-readable medium storing code for wireless communications at a network entity is described. The code may include instructions executable by a processor to output an indication of prioritization information associated with a first cell and a second cell. In some examples, the prioritization information may indicate one or more parameters for prioritization of the first cell or the second cell for MBS communications within a geographic service area. The instructions may be further executable by the processor to output, via the first cell, an MBS message within the geographic service area supported by the first cell and the second cell.

Some examples of the method, apparatuses, and non-transitory computer-readable medium described herein may further include operations, features, means, or instructions for encrypting the MBS message based on an encryption key that corresponds to the first cell.

Some examples of the method, apparatuses, and non-transitory computer-readable medium described herein may further include operations, features, means, or instructions for outputting a multicast control message that indicates a set of cells associated with the geographic service area and a network type associated with the set of cells.

Some examples of the method, apparatuses, and non-transitory computer-readable medium described herein may further include operations, features, means, or instructions for outputting a multicast control message that indicates an association between one or more decryption keys and one or more cells or frequencies associated with the geographic service area, a time duration for which the association is valid, or both.

### BRIEF DESCRIPTION OF THE DRAWINGS

FIG. 1 illustrates an example of a wireless communications system that supports broadcast communications for terrestrial and non-terrestrial cells in accordance with one or more aspects of the present disclosure.

FIGS. 2 and 3 illustrate examples of wireless communications systems that support broadcast communications for terrestrial and non-terrestrial cells in accordance with one or more aspects of the present disclosure.

FIGS. 4 through 7 illustrate examples of process flows that support broadcast communications for terrestrial and non-terrestrial cells in accordance with one or more aspects of the present disclosure.

FIGS. 8 and 9 show block diagrams of devices that support broadcast communications for terrestrial and non-terrestrial cells in accordance with one or more aspects of the present disclosure.

FIG. 10 shows a block diagram of a communications manager that supports broadcast communications for terrestrial and non-terrestrial cells in accordance with one or more aspects of the present disclosure.

FIG. 11 shows a diagram of a system including a device that supports broadcast communications for terrestrial and non-terrestrial cells in accordance with one or more aspects of the present disclosure.

FIGS. 12 and 13 show block diagrams of devices that support broadcast communications for terrestrial and non-terrestrial cells in accordance with one or more aspects of the present disclosure.

FIG. 14 shows a block diagram of a communications manager that supports broadcast communications for terrestrial and non-terrestrial cells in accordance with one or more aspects of the present disclosure.

FIG. 15 shows a diagram of a system including a device that supports broadcast communications for terrestrial and non-terrestrial cells in accordance with one or more aspects of the present disclosure.

FIGS. 16 through 23 show flowcharts illustrating methods that support broadcast communications for terrestrial and non-terrestrial cells in accordance with one or more aspects of the present disclosure.

### DETAILED DESCRIPTION

In some wireless communications systems, a UE may receive one or more communications via a cell of a non-terrestrial network (NTN). As described herein, a cell may refer to a combination of frequency resources (e.g., carrier frequencies) and spatial resources (e.g., geographic zones) used for wireless communications. An NTN may refer to a wireless communications system that includes non-terrestrial communication devices such as satellites, zeppelins, dirigibles, balloons, or drones, among other examples. An NTN cell may be supported by a non-terrestrial communication device such as a satellite, a zeppelin, a dirigible, a balloon, a drone, or another aerial device. An NTN cell have a relatively large coverage area that spans hundreds of kilometers. All UEs within this coverage area may receive communications via the NTN cell, even if some UEs are unauthorized to receive such communications. That is, a UE within the coverage area supported by the NTN cell may receive and decode communications via the NTN cell, regardless of whether such communications are intended for the UE. Moreover, the NTN cell (or a network entity associated with the NTN cell) may have a relatively high velocity with respect to UEs that are stationary. As such, a stationary UE may perform a relatively large number of cell reselection procedures to maintain communications with the NTN cell, which may result in higher latency and greater power consumption at the UE.

Aspects of the present disclosure may support techniques for managing multicast and broadcast service (MBS) communications in a geographic service area supported by one or more NTN cells and terrestrial network (TN) cells. MBS may refer to a point-to-multipoint service in which the same content is communicated to multiple users or recipient devices. Although described in the context of MBS communications, it is to be understood that the techniques described herein are also applicable to multimedia broadcast multicast service (MBMS) communications, multicast communications, broadcast communications, and all other communication services that can be received by multiple devices. In accordance with the techniques described herein, a UE may receive a control message, such as a non-access spectrum (NAS) message or a radio resource control (RRC) message, indicating a decryption key for MBS communications within a geographic service area supported by one or more cells. As described herein, a geographic service area may refer to a geographic region or zone configured for MBS communications. A geographic service area may be defined by a tracking area, a physical cell identifier (PCID), a beam identifier, a frequency, a coverage area, a country, or a combination thereof.

In some examples, the UE may also receive geographic information associated with the geographic service area supported by the one or more NTN cells (also referred to herein as non-terrestrial cells) and TN cells (also referred to herein as terrestrial cells). This geographic information may include a list of cells, frequencies, beams, tracking areas, or tracking area codes (TACs) associated with the geographic service area. Additionally, or alternatively, the UE may receive synchronization information and prioritization information for one or more NTN cells or TN cells that support the geographic service area. As described herein, the synchronization information may enable the UE to receive synchronized (e.g., concurrent, simultaneous) MBS communications via multiple NTN cells or TN cells within the geographic service area, while the prioritization information may enable the UE to prioritize one or more NTN cells or TN cells for MBS communications within the geographic service area. As used herein, the terms “concurrent” and “simultaneous” may refer to events or operations that occur within a relatively short time span.

The techniques described herein may enable a network entity to regulate which UEs can receive MBS communications from the network entity by encrypting some or all of the MBS communications and providing authorized UEs (e.g., UEs within an authorized geographic service area of the network entity) with a corresponding decryption key. The authorized UEs may use the decryption key provided by the network entity to decrypt the MBS communications, while unauthorized UEs (e.g., UEs outside an authorized geographic service area of the network entity) may be unable to decrypt the MBS communications. The techniques described herein may also reduce the amount of time that authorized UEs spend performing cell search and selection by providing these authorized UEs with geographic information, synchronization information, and prioritization information that can assist with cell search and selection. Further, the number of times cell reselection performed by an authorized UE may be reduced due to improved cell selection. In some cases, authorized UEs may be capable of communicating MBS communications with the network entity, while unauthorized UEs may be blocked.

Aspects of the disclosure are initially described in the context of wireless communications systems and process flows. Aspects of the disclosure are further illustrated by and described with reference to apparatus diagrams, system diagrams, and flowcharts that relate to broadcast communications for terrestrial and non-terrestrial cells.

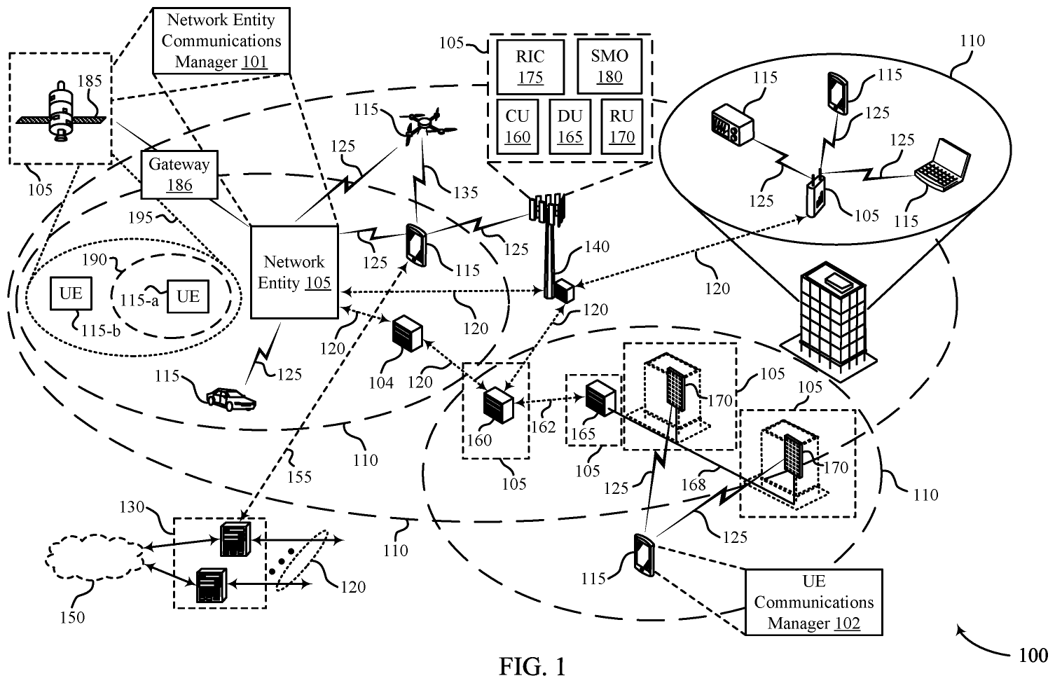

FIG. 1 illustrates an example of a wireless communications system 100 that supports broadcast communications for terrestrial and non-terrestrial cells in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support broadcast communications for terrestrial and non-terrestrial cells, as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a PCID, a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell covers a relatively large geographic area (e.g., several kilometers in radius) and may enable unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, be unaligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or other functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage NAS functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). The region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs regarding FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FRI or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, or FR5, or may be within the EHF band.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

As described herein, a node, which may be referred to as a node, a network node, a network entity, or a wireless node, may be a base station 140 (e.g., any base station described herein), a UE 115 (e.g., any UE described herein), a network controller, an apparatus, a device, a computing system, one or more components, or another suitable processing entity configured to perform any of the techniques described herein. For example, a network node may be a UE 115. As another example, a network node may be a base station 140. As another example, a first network node may be configured to communicate with a second network node or a third network node. In one aspect of this example, the first network node may be a UE 115, the second network node may be a base station 140, and the third network node may be a UE 115. In another aspect of this example, the first network node may be a UE 115, the second network node may be a base station 140, and the third network node may be a base station 140. In yet other aspects of this example, the first, second, and third network nodes may be different relative to these examples.

Similarly, reference to a UE 115, a base station 140, apparatus, device, computing system, or the like may include disclosure of the UE 115, base station 140, apparatus, device, computing system, or the like being a network node. For example, disclosure that a UE 115 is configured to receive information from a base station 140 also discloses that a first network node is configured to receive information from a second network node. Consistent with this disclosure, once a specific example is broadened in accordance with this disclosure (e.g., a UE 115 is configured to receive information from a base station 140 also discloses that a first network node is configured to receive information from a second network node), the broader example of the narrower example may be interpreted in the reverse, but in a broad open-ended way. In the example above where a UE 115 being configured to receive information from a base station 140 also discloses that a first network node being configured to receive information from a second network node, the first network node may refer to a first UE 115, a first base station 140, a first apparatus, a first device, a first computing system, a first one or more components, a first processing entity, or the like configured to receive the information; and the second network node may refer to a second UE 115, a second base station 140, a second apparatus, a second device, a second computing system, a first one or more components, a first processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

A network entity communications manager 101 may manage communications between a network entity 105 and other devices in the wireless communications system 100. As described herein, a network entity 105 may refer to a terrestrial communication device (such as a base station 140) or a non-terrestrial communication device (such as a satellite 185). A non-terrestrial network entity 105 may be connected to a terrestrial network entity 105 via a gateway 186. In a similar manner, a UE communications manager 102 may manage communications between a UE 115 and other devices in the wireless communications system 100.

Some wireless communications systems may support broadcast communication services, where the same content is simultaneously provided to all UEs 115 within a geographic service area. All UEs 115 in the geographic service area may be authorized to receive the content (e.g., data). A broadcast communication service may be delivered to UEs 115 during a broadcast session. A UE 115 may receive a broadcast communication service in an idle state (e.g., RRC_IDLE), an inactive state (e.g., RRC_INACTIVE), or a connected state (e.g., RRC_CONNECTED). In some NTNs, however, a communication beam 195 of a satellite 185 (e.g., an NTN cell) may cover a relatively large area that spans multiple countries and broadcast service areas. Moreover, if the satellite 185 changes locations, a stationary UE 115 may perform a relatively large number of cell reselection procedures to maintain communications with the satellite 185.

Aspects of the present disclosure may support techniques for using a decryption key to regulate access to broadcast services in unauthorized service areas. More specifically, a network entity communications manager 101 of a network entity 105 may provide a UE communications manager 102 of a UE 115 with one or more decryption key via NAS or RRC signaling. Aspects of the present disclosure may also enable a UE communications manager 102 of a UE 115 to perform cell selection with greater efficiency by providing the UE communications manager 102 of UE 115 with synchronization information and prioritization information for nearby NTN cells and TN cells that support MBS communications, which may assist cell selection processes at the UE 115.

The wireless communications system 100 may support techniques for regulating access to MBS communications in an NTN. For example, the techniques and operations described with reference to FIG. 1 may enable a UE 115 to receive encrypted MBS communications via one or more NTN cells and TN cells. As an example, a network entity 105 (e.g., a satellite 185 or another aerial communication device) may provide a decryption key for encrypted MBS communications to a UE 115-a if the UE 115-a is located within an authorized geographic service area 190 of the network entity 105. The UE 115-a may use the decryption key to decode the encrypted MBS communications, whereas a UE 115-b may be unable to decode the encrypted MBS communications, even if the UE 115-b is within the communication beam 195 of the network entity (e.g., because the UE 115-b is outside the authorized geographic service area 190). The network entity 105 may also provide the UE 115-a with additional geographic information, synchronization information, and prioritization information, which may assist the UE 115-a with cell search and selection.

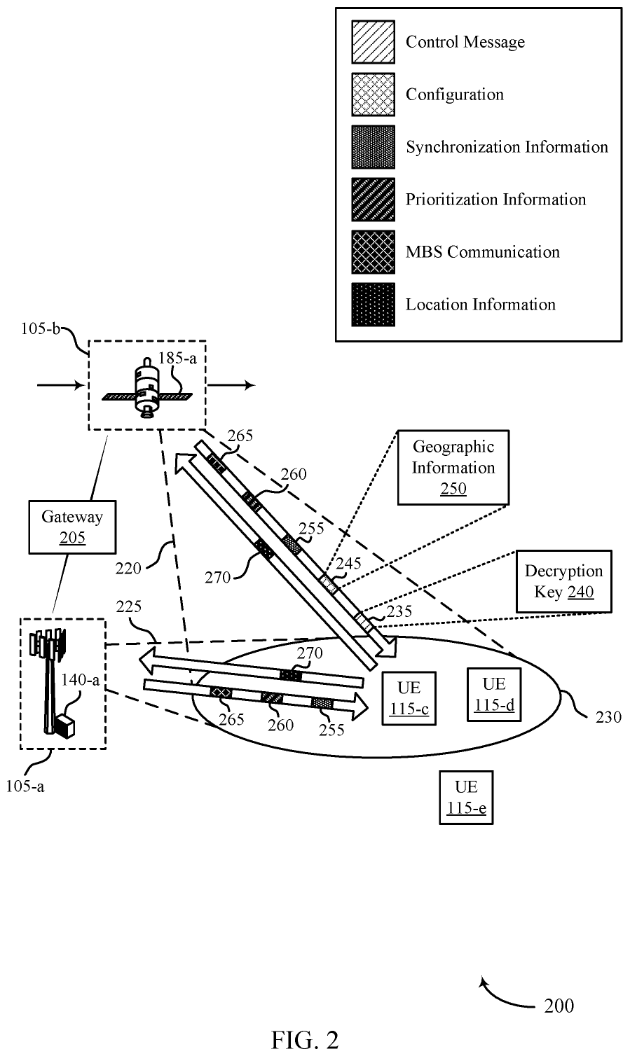

FIG. 2 illustrates an example of a wireless communications system 200 that supports broadcast communications for terrestrial and non-terrestrial cells in accordance with one or more aspects of the present disclosure. The wireless communications system 200 may implement or be implemented by aspects of wireless communications system 100. For example, the wireless communications system 200 may include a network entity 105-a (e.g., a terrestrial communication device), a network entity 105-b (e.g., a non-terrestrial communication device), a UE 115-c, a UE 115-d, and a UE 115-e, which may be examples of corresponding devices described with reference to FIG. 1. The network entity 105-a may include a base station 140-a, which may be an example of a base station 140 described with reference to FIG. 1. Likewise, the network entity 105-b may include a satellite 185-a, which may be an example of a satellite 185 described with reference to FIG. 1. The network entity 105-a may be connected to the network entity 105-b via a gateway 205, which may be an example of a gateway 186 described with reference to FIG. 1. The wireless communications system 200 may support techniques for regulating access to MBS communications within a geographic service area 230 supported by an NTN cell 220 of the network entity 105-b and a TN cell 225 of the network entity 105-a.

As depicted in the example of FIG. 2, the UE 115-c may receive a control message 235 from the network entity 105-b. The control message 235, which may be an example of a NAS message or an RRC message, may indicate a decryption key 240 for MBS communications within the geographic service area 230 supported by the NTN cell 220 of the network entity 105-b and the TN cell 225 of the network entity 105-a. In some examples, the decryption key 240 may depend on a cell identifier (e.g., a PCID) of the NTN cell 220, a beam index corresponding to the NTN cell 220, a TAC corresponding to the geographic service area 230, or an index associated with a current location of the UE 115-c. The decryption key 240 may also depend on a key or counter value provided by the network entity 105-b. In some examples, the decryption key 240 may be valid for a specific time interval.

In some examples, the UE 115-c may transmit location information 270 to one or both of the network entity 105-a or the network entity 105-b. The location information 270 may indicate a current tracking area of the UE 115-c, an index associated with a current location of the UE 115-c, an identifier of the geographic service area 230, or a combination thereof. Additionally, or alternatively, the UE 115-c may receive an indication of a configuration 245 for the geographic service area 230. The configuration 245 may include geographic information 250 associated with the geographic service area 230. The geographic information 250 may include a set of tracking areas or TACs associated with the geographic service area 230, a set of cells or frequencies corresponding to the geographic service area 230, or geo-fencing information associated with the geographic service area 230. In some examples, the UE 115-c may also receive an indication of a time for which the configuration 245 of the geographic service area 230 is valid.

The UE 115-c may also receive synchronization information 255 or prioritization information 260 from one or both of the network entity 105-a or the network entity 105-b. The synchronization information 255 may indicate a delay offset applied to MBS communications from the network entity 105-a or the network entity 105-b. For example, if there is a propagation delay between the network entity 105-b and the network entity 105-a, the network entity 105-b may apply a delay offset to MBS communications such that MBS communications from the network entity 105-a and the network entity 105-b arrive at the UE 115-c at approximately the same time. The prioritization information 260 may include one or more parameters for determining whether to prioritize the NTN cell 220 or the TN cell 225 for MBS communications within the geographic service area 230.

The UE 115-c may use the prioritization information 260 to perform cell search and selection with improved efficiency and reduced latency. For example, the UE 115-c may determine to prioritize the NTN cell 220 for MBS communications based on the prioritization information 260 provided by the network entity 105-a. Accordingly, the UE 115-c may camp on (e.g., monitor for communications from) the NTN cell 220 rather than searching for nearby cells, measuring reference signals from the nearby cells, and selecting a cell based on the reference signals (which may result in latency and extraneous power consumption at the UE 115-c).

Accordingly, the UE 115-c and the UE 115-d (e.g., another UE in the geographic service area 230) may receive an MBS communication 265 within the geographic service area 230. The UE 115-c and the UE 115-d may receive the MBS communication 265 via the NTN cell 220 of the network entity 105-b, the TN cell 225 of the network entity 105-a, or both. In some examples, the network entity 105-a or the network entity 105-b may apply a delay offset to the MBS communication 265, which may enable the UE 115-c and the UE 115-d to concurrently receive (e.g., at approximately the same time) the MBS communication 265 from the network entity 105-a and the network entity 105-b. The MBS communication 265 may include multicast control channel (MCCH) data, multicast traffic channel (MTCH) data, or both. In some examples, the MTCH data may be encrypted, while the MCCH data may be unencrypted. In such examples, the UE 115-c and the UE 115-d may use the decryption key 240 to decrypt the MTCH data.

The wireless communications system 200 may support techniques for regulating access to MBS communications within the geographic service area 230. For example, the techniques and operations described with reference to FIG. 2 may enable the network entity 105-b (e.g., a satellite) to encrypt the MBS communication 265 and transmit the encrypted MBS communication 265 via the NTN cell 220. For example, if the UE 115-c and the UE 115-d are located within the geographic service area 230 (e.g., an authorized geographic service area of the network entity 105-b), the network entity 105-b may provide the UE 115-c and the UE 115-d with the decryption key 240 for the encrypted MBS communication 265. The UE 115-c and the UE 115-d may use the decryption key 240 to decode the encrypted MBS communication 265, while the UE 115-e may be unable to decode the encrypted MBS communication 265 (e.g., because the UE 115-e is outside the geographic service area 230.

One or both of the network entity 105-a or the network entity 105-b may also provide the UE 115-c and the UE 115-d with geographic information 250, synchronization information 255, and prioritization information 260, which may increase the likelihood of the UE 115-c and the UE 115-d successfully receiving the MBS communication 265. For example, the synchronization information 255 may enable the UE 115-c and the UE 115-d to receive the MBS communication 265 from the network entity 105-a and the network entity 105-b at approximately the same time (e.g., in a synchronized or concurrent manner). As such, if channel conditions between the network entity 105-a and the UE 115-c deteriorate, the UE 115-c may still be capable of receiving the MBS communication 265 from the network entity 105-b (and vice versa).

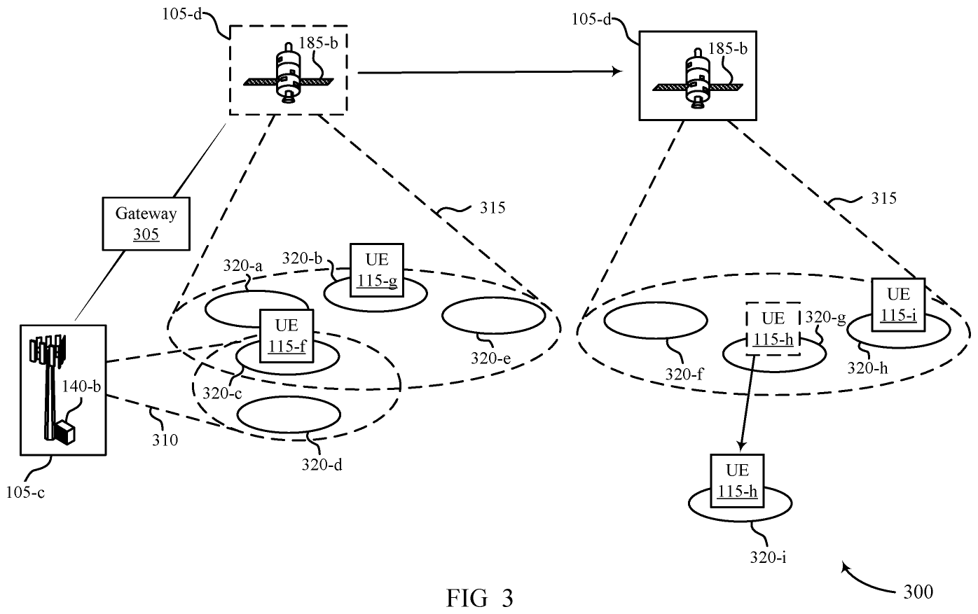

FIG. 3 illustrates an example of a wireless communications system 300 that supports broadcast communications for terrestrial and non-terrestrial cells in accordance with one or more aspects of the present disclosure. The wireless communications system 300 may implement or be implemented by aspects of the wireless communications system 100 or the wireless communications system 200. For example, the wireless communications system 300 may include a network entity 105-c (e.g., a terrestrial communication device), a network entity 105-d (e.g., a non-terrestrial communication device), a UE 115-f, a UE 115-g, a UE 115-h, and a UE 115-i, which may be examples of corresponding devices described with reference to FIGS. 1 and 2. The network entity 105-c may include a base station 140-b, which may be an example of a base station 140 described with reference to FIG. 1. Likewise, the network entity 105-d may include a satellite 185-b, which may be an example of a satellite 185 described with reference to FIG. 1. The network entity 105-c may be connected to the network entity 105-d via a gateway 305, which may be an example of a gateway 186 or a gateway 205 described with reference to FIGS. 1 and 2. The wireless communications system 300 may support techniques for managing MBS communications in different geographic service areas.

As illustrated in the example of FIG. 3, a communication beam 310 of the network entity 105-c (also referred to herein as a TN cell) may span a tracking area 320-c and a tracking area 320-d. Similarly, a communication beam 315 of the network entity 105-d may span a tracking area 320-a, a tracking area 320-b, the tracking area 320-c, and a tracking area 320-e. The UE 115-f may be located in the tracking area 320-c, and the UE 115-g may be located in the tracking area 320-b. If, for example, the network entity 105-d moves to a second location, the communication beam 315 of the network entity 105-d may span a tracking area 320-f, a tracking area 320-g, and a tracking area 320-h. The UE 115-h may be located in the tracking area 320-g at a first time, and may move to a tracking area 320-i at a second time. The UE 115-i may be located in the tracking area 320-h.

For NTNs, tracking areas may be earth-fixed geographic zones, while NTN cells (e.g., satellites) may be mobile. Geographic serving areas can be configured with respect to earth-fixed tracking areas. Since a satellite beam (e.g., an NTN cell) may span multiple tracking areas, MBS communications can be received in undesired areas. To manage which service areas have access to MBS communications, a network or service layer may configure (e.g., via a NAS message or an RRC message) a decryption key for the MBS communications. The UE 115-f can be provided with different decryption keys for different geographic service areas. An MBS transport function of the network entity 105-d can retrieve a location of the UE 115-f and provide the UE 115-f with decryption keys for content that is applicable to a location (e.g., country, service area) of the UE 115-f.

In some examples, the UE 115-f may derive a decryption key for MBS communications based on a cell identifier, an index of the communication beam 310, a TAC of the tracking area 320-c, or an index associated with a location of the UE 115-f. Additionally, or alternatively, the UE 115-f may derive a decryption key from a key or counter value provided by the network or service layer. In some examples, a first portion of an MBS communication may be encrypted, while a second portion of the MBS communication may be unencrypted. For example, if an MBS communication includes MTCH data and MCCH data, the MTCH data may be encrypted, while the MCCH data may be unencrypted. Authorized UEs can decode the encrypted MTCH data, whereas the MCCH data can be received by all UEs.

If an MBS communication includes both MCCH data and MTCH data, the MCCH data can also include an indication of whether the MTCH data is encrypted. This may enable the UE 115-f to determine whether to receive the MTCH data (e.g., depending on whether a valid encryption key for the MTCH data is available to the UE 115-f). The MCCH data can also indicate whether an encryption key used to encrypt the MTCH data has changed within a prior time period. The network entity 105-d may transmit a paging message to notify the UE 115-f of an encryption key change. The MCCH data may also indicate an index of a credential (e.g., encryption key), which the UE 115-f may use to identify which encryption key was used to encrypt the MTCH data. In such examples, the UE 115-f may be configured with multiple decryption keys. These decryption keys may be time-variant and based on a movement pattern of the network entity 105-d (e.g., a satellite).

In some examples, the UE 115-h may move from the tracking area 320-g to a tracking area 320-i and may determine that the UE 115-h is unable to decrypt the MTCH data (e.g., based on a TAC of the tracking area 320-i or a location index of the UE 115-h. In such examples, the UE 115-h may attempt to receive MBS communications from a different cell. Additionally, or alternatively, the UE 115-h may attempt to decode the MTCH using a different decryption key. If the UE 115-f is located in the tracking area 320-c (which is covered by the communication beam 315) and the network entity 105-d moves from a first location to a second location such that the tracking area 320-c is outside the communication beam 315 of the network entity 105-d, the UE 115-f may determine to prioritize the network entity 105-c for MBS communications.

The wireless communications system 300 may support techniques for regulating access to MBS communications within different geographic service areas. For example, the techniques and operations described with reference to FIG. 3 may enable the UE 115-f to receive encrypted MBS communications via the communication beam 310 of the network entity 105-c or the communication beam 315 of the network entity 105-d. If, for example, the UE 115-f is located within an authorized geographic service area of the network entity 105-d, the network entity 105-d may provide the UE 115-f with a decryption key for the encrypted MBS communication. As such, the UE 115-f may use the decryption key to decode the encrypted MBS communication, while the UE 115-i (e.g., a UE outside the authorized geographic service area of the network entity 105-d) may be unable to decode the encrypted MBS communication. One or both of the network entity 105-c or the network entity 105-d may also provide the UE 115-f with additional geographic information, synchronization information, and prioritization information, which may reduce the amount of time that the UE 115-f spends performing cell search and selection (e.g., while monitoring for MBS communications).

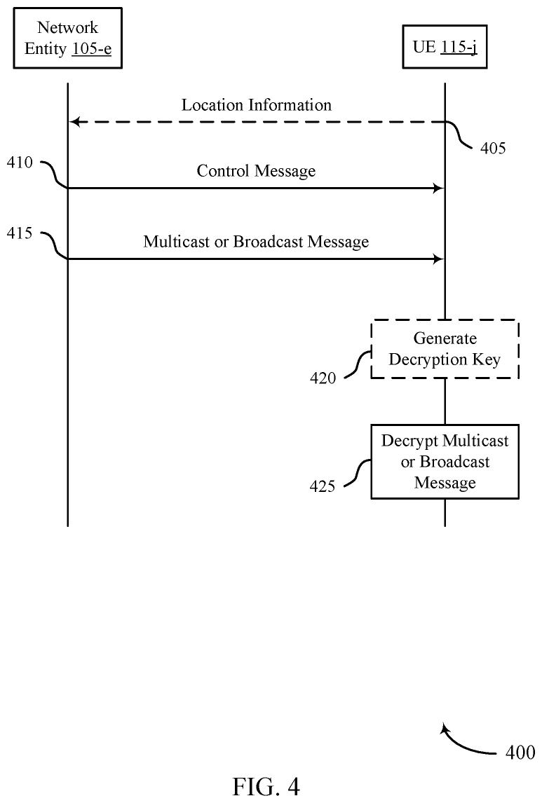

FIG. 4 illustrates an example of a process flow 400 that supports broadcast communications for terrestrial and non-terrestrial cells in accordance with one or more aspects of the present disclosure. The process flow 400 may implement or be implemented by aspects of the wireless communications system 100, the wireless communications system 200, or the wireless communications system 300. For example, the process flow 400 may include a network entity 105-e and a UE 115-j, which may be examples of corresponding devices described with reference to FIGS. 1 through 3. In the following description of the process flow 400, operations between the network entity 105-e and the UE 115-j may be performed in different orders or at different times. Additionally, or alternatively, some operations may be omitted from the process flow 400, and other operations may be added to the process flow 400. In the example of FIG. 4, the network entity 105-e may provide the UE 115-j with a decryption key for MBS communications within a geographic service area.

In some examples, the UE 115-j may transmit location information (e.g., information associated with a current location of the UE 115-j) to the network entity 105-e at 405. The location information may include, for example, a current tracking area of the UE 115-j or an index associated with a current location of the UE 115-j. The network entity 105-e may use this location information to determine which services (e.g., MBS, MBMS) are applicable to the UE 115-j. At 410, the UE 115-j may receive a control message from the network entity 105-e. The control message may indicate a decryption key (or information that can be used to derive the decryption key) for MBS communications within a geographic service area supported by a cell of the network entity 105-e.

In some examples, the network entity 105-e may configure the UE 115-j with multiple decryption keys corresponding to different geographic service areas. These decryption keys may be a function of a cell identifier, a beam index, a TAC, an index associated with a current location of the UE 115-j, a key or counter value provided by the network entity 105-e, or a combination thereof. The network entity 105-e may configure the UE 115-j with these decryption keys via a NAS message or an RRC message, among other examples. The network entity 105-e may provide the UE 115-j with decryption keys for services that the UE 115-j is authorized to receive, which may depend on a current location of the UE 115-j.

At 415, the UE 115-j may receive (via the cell of the network entity 105-e) an MBS communication within the geographic service area supported by the cell of the network entity 105-e. The MBS communication may include MCCH data, MTCH data, or both. In some examples, the MTCH data may be encrypted, while the MCCH data may be unencrypted. The MCCH data may, in some examples, indicate whether the MTCH data is encrypted or whether an encryption key for the MTCH data has changed within a time interval. The MCCH data may also indicate a specific encryption key (or an index of an encryption key) used for encryption of the MTCH data. At 420, the UE 115-j may generate (e.g., derive) a decryption key for the MBS communication based on information provided by the network entity 105-e. Accordingly, the UE 115-j may use the decryption key to decrypt at least a portion of the MBS communication at 425.

The process flow 400 may support techniques for regulating access to MBS communications within a geographic service area. For example, the techniques and operations described with reference to FIG. 4 may enable the network entity 105-e to transmit an encrypted MBS communication to the UE 115-j via an NTN cell. If, for example, the UE 115-j is located within an authorized geographic service area supported by the NTN cell, the network entity 105-e may provide the UE 115-j with a decryption key for the encrypted MBS communication. As such, the UE 115-j may use the decryption key to decode the encrypted MBS communication, while other UEs outside the authorized geographic service area may be unable to decode the encrypted MBS communication. The network entity 105-e may also provide the UE 115-j with additional geographic information, synchronization information, and prioritization information, which may improve the likelihood of the UE 115-j successfully receiving the encrypted MBS communication (e.g., by enabling the UE 115-j to receive concurrent MBS communications via multiple cells).

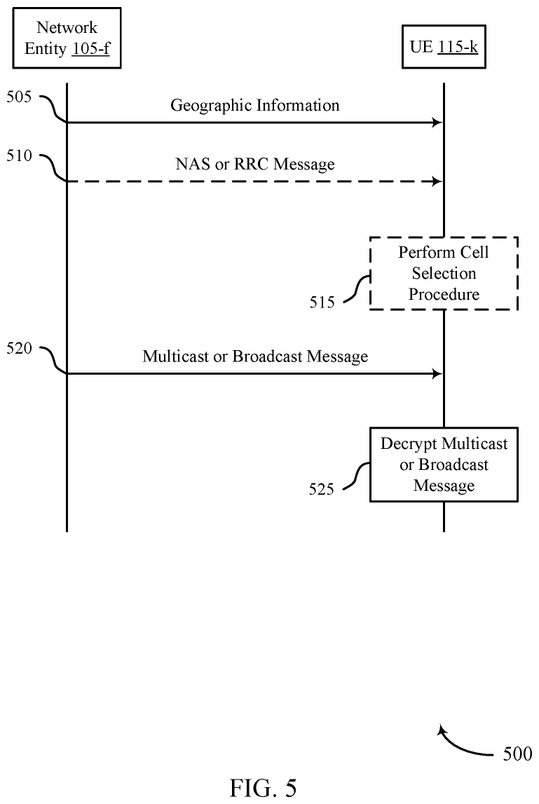

FIG. 5 illustrates an example of a process flow 500 that supports broadcast communications for terrestrial and non-terrestrial cells in accordance with one or more aspects of the present disclosure. The process flow 500 may implement or be implemented by aspects of the wireless communications system 100, the wireless communications system 200, or the wireless communications system 300. For example, the process flow 500 may include a network entity 105-f and a UE 115-k, which may be examples of corresponding devices described with reference to FIGS. 1 through 3. In the following description of the process flow 500, operations between the network entity 105-f and the UE 115-k may be performed in different orders or at different times. Additionally, or alternatively, some operations may be omitted from the process flow 500, and other operations may be added to the process flow 500. In the example of FIG. 5, the network entity 105-f may provide the UE 115-k with geographic information associated with a geographic service area supported by a cell of the network entity 105-f.

A geographic service area, also referred to herein as a MBMS (MBMS) service area, an MBS service area, or a geographic coverage area, may be configured as a combination of a tracking area, a PCID, a beam index, and a frequency. A list of tracking areas and a list of cells (e.g., PCIDs and frequencies) can be provided to the UE 115-k via dedicated signaling or a broadcast message. In some examples, the UE 115-k may also receive an indication of a mapping between TACs and geographic locations. Thus, if the UE 115-k moves to a different tracking area, the UE 115-k may determine which cells or frequencies correspond to the different tracking area (e.g., using the mapping), and may perform cell search and selection accordingly.

The UE 115-k may also be configured with a time for which a geographic service area is valid. This validity time may be provided with the list of cells and frequencies for a geographic service area. For moving cells (e.g., NTN cells), cell identifiers and frequencies may change within a given tracking area. The UE 115-k can determine which cell or frequency to prioritize (for cell search and selection) based on the validity time for the geographic service area. Additionally, or alternatively, the UE 115-k may receive a list of TACs in a broadcast transmission from a serving cell of the UE 115-k or a broadcast transmission from a previous serving cell of the UE 115-k. This may assist the UE 115-k with cell search and selection for stationary cells (e.g., TN cells). In some examples, the UE 115-k may also receive a NAS message or an RRC message indicating geo-fencing information for a geographic service area. The UE 115-k may use this geo-fencing information to determine which geographic service area to prioritize during cell search and selection.

At 505, the UE 115-k may receive an indication of a configuration for a geographic service area supported by a cell of the network entity 105-f. The configuration may include geographic information associated with the geographic service area, a set of tracking areas associated with the geographic service area, a set of cell identifiers associated with the geographic service area, a set of frequencies associated with the geographic service area, or a combination thereof. The UE 115-k may receive the indication of the configuration via dedicated signaling or a broadcast message, among other examples. The UE 115-k may also receive an indication of one or more decryption keys (or information that can be used to derive a decryption key) for MBS communications within the geographic service area supported by the cell of the network entity 105-f.

Additionally, or alternatively, the UE 115-k may receive an indication of an association (e.g., mapping) between a set of TACs and a set of tracking areas within the geographic service area supported by the cell of the network entity 105-f. The UE 115-k may also receive an indication of a time duration for which the configuration of the geographic service area is valid. In some examples, the UE 115-k may receive a NAS message or an RRC message (e.g., via the cell of the network entity 105-f) at 510. The NAS message or the RRC message may indicate geo-fencing information associated with the geographic service area. In some examples, the UE 115-k may perform a cell selection procedure at 515 based on the geo-fencing information indicated by the NAS message or the RRC message.

At 520, the UE 115-k may receive an MBS message within the geographic service area supported by the cell of the network entity 105-f. In some examples, the UE 115-k may derive a decryption key for the MBS message based on the geographic information associated with the geographic service area supported by the cell of the network entity 105-f, the geo-fencing information indicated by the NAS message or the RRC message, the association between TACs and tracking areas within the geographic service area supported by the cell of the network entity 105-f, or other information provided by the network entity 105-f. Accordingly, the UE 115-k may decrypt the MBS message (using a corresponding decryption key) at 525.

The process flow 500 may support techniques for regulating access to MBS communications within a geographic service area. For example, the techniques and operations described with reference to FIG. 5 may enable the network entity 105-f to transmit an encrypted MBS communication to the UE 115-k via an NTN cell. If, for example, the UE 115-k is located within an authorized geographic service area supported by the NTN cell, the network entity 105-f may provide the UE 115-k with a decryption key for the encrypted MBS communication. As such, the UE 115-k may use the decryption key to decode the encrypted MBS communication, while other UEs outside the authorized geographic service area may be unable to decode the encrypted MBS communication. The network entity 105-f may also provide the UE 115-k with additional geographic information, synchronization information, and prioritization information, which may assist with cell search and selection procedures at the UE 115-k.

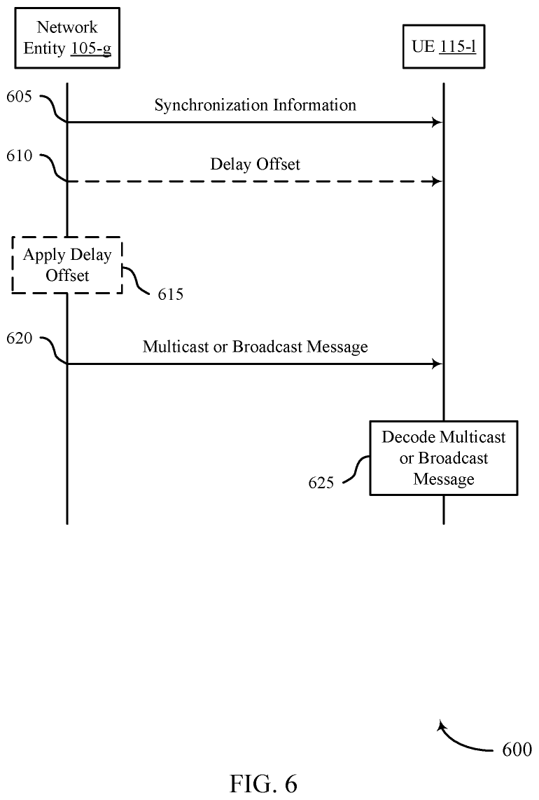

FIG. 6 illustrates an example of a process flow 600 that supports broadcast communications for terrestrial and non-terrestrial cells in accordance with one or more aspects of the present disclosure. The process flow 600 may implement or be implemented by aspects of the wireless communications system 100, the wireless communications system 200, or the wireless communications system 300. For example, the process flow 600 may include a network entity 105-g and a UE 115-1, which may be examples of corresponding devices described with reference to FIGS. 1 through 3. In the following description of the process flow 600, operations between the network entity 105-g and the UE 115-1 may be performed in different orders or at different times. Additionally, or alternatively, some operations may be omitted from the process flow 600, and other operations may be added to the process flow 600. In the example of FIG. 6, the network entity 105-g may provide the UE 115-1 with synchronization information, which may enable the UE 115-1 to receive synchronized (e.g., simultaneous, concurrent) MBS communications from multiple network entities.

The process flow 600 may support techniques for service continuity between different network types. For example, the process flow 600 may support synchronization of MBS communications between TN cells and NTN cells, which may enable the UE 115-1 to concurrently (e.g., synchronously) receive the same MBS communications via multiple TN cells or NTN cells. For example, the UE 115-1 may be capable of receiving MBS communications via a TN and an NTN. In other examples, the UE 115-1 may prioritize either the TN or the NTN for MBS transmissions based on which network has a higher signal quality. In some examples, the UE 115-1 may operate in a receive-only mode when monitoring for MBS communications. While operating in receive-only mode, the UE 115-1 may receive the same MBS communications via TN cells, NTN cells, or both. The UE 115-1 may also support a multi-universal subscriber identity module (MUSIM), where one subscriber identity module (SIM) is dedicated to receiving MBS communications.

In some examples, a propagation delay for NTN cells may be larger than a propagation delay for TN cells. To manage this propagation delay, either the TN cells may delay MBS communications by a delay offset, or the NTN cells may begin the MBS communications earlier (by a corresponding offset value). The delay offset can be introduced in the SYNC protocol layer. Additionally, or alternatively, the delay offset may be provided to the UE 115-1. Accordingly, the UE 115-1 can decide whether to delay receiving MBS communications and refrain from decoding redundant packets (e.g., for early transmissions from TN to NTN), or whether to receive MBS packets over downlink data (e.g., for delayed transmissions from NTN to TN).

At 605, the UE 115-1 may receive an indication of synchronization information associated with a first cell (e.g., an NTN cell) and a second cell (e.g., a TN cell) that support MBS communications within a geographic coverage area. The first cell may correspond to the network entity 105-g (e.g., a satellite), whereas the second cell may correspond to a different network entity (e.g., a base station). In some examples (e.g., if there is a propagation delay between the first cell and the second cell), the UE 115-1 may receive an indication of a delay offset at 610. The delay offset may enable the network entity 105-g to synchronize transmissions from the first cell and the second cell. Providing the UE 115-1 with an indication of the delay offset may increase the likelihood of the UE 115-1 successfully receiving synchronized MBS communications from the first cell and the second cell. At 615, the network entity 105-g may apply the delay offset to an MBS communication.

At 620, the network entity 105-g may transmit the MBS communication with the delay offset applied. At 625, the UE 115-1 may receive the MBS communication within the geographic service area supported by the first cell and the second cell, and may decode the MBS communication based on the synchronization information provided by the network entity 105-g. In some examples (e.g., if the MBS communication is encrypted), the UE 115-1 may decrypt the MBS communication using a decryption key that corresponds to the first cell, the second cell, the geographic service area, a location of the UE 115-1, or a combination thereof.

The process flow 600 may support techniques for regulating access to MBS communications within a geographic service area. For example, the techniques and operations described with reference to FIG. 6 may enable the network entity 105-g to transmit an encrypted MBS communication to the UE 115-1 via an NTN cell. If, for example, the UE 115-1 is located within an authorized geographic service area supported by the NTN cell, the network entity 105-g may provide the UE 115-1 with a decryption key for the encrypted MBS communication. As such, the UE 115-1 may use the decryption key to decode the encrypted MBS communication, while other UEs outside the authorized geographic service area may be unable to decode the encrypted MBS communication. The network entity 105-g may also provide the UE 115-1 with additional geographic information, synchronization information, and prioritization information to improve cell search and selection procedures at the UE 115-1.

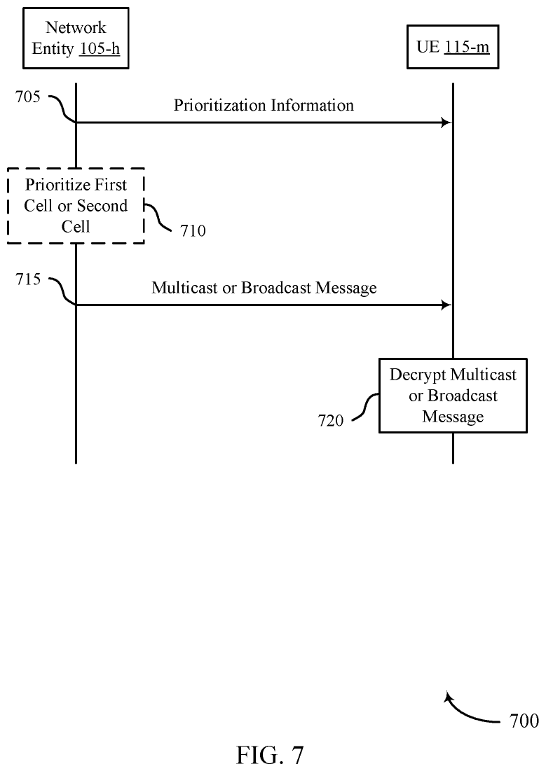

FIG. 7 illustrates an example of a process flow 700 that supports broadcast communications for terrestrial and non-terrestrial cells in accordance with one or more aspects of the present disclosure. The process flow 700 may implement or be implemented by aspects of the wireless communications system 100, the wireless communications system 200, or the wireless communications system 300. For example, the process flow 700 may include a network entity 105-h and a UE 115-m, which may be examples of corresponding devices described with reference to FIGS. 1 through 3. In the following description of the process flow 700, operations between the network entity 105-h and the UE 115-m may be performed in different orders or at different times. Additionally, or alternatively, some operations may be omitted from the process flow 700, and other operations may be added to the process flow 700. In the example of FIG. 7, the network entity 105-h may provide the UE 115-m with prioritization information for one or more cells (e.g., NTN cells or TN cells) that support MBS communications.

In some cases, the UE 115-m may be configured to prioritize a TN cell or a TN frequency for MBS communications (regardless of NTN channel conditions). In accordance with aspects of the present disclosure, if the UE 115-m is receiving an MBS communication from an NTN cell of the network entity 105-h, the UE 115-m may prioritize the NTN cell over other TN cells to continue receiving MBS communications. In some examples, a neighbor cell list provided via an MCCH can indicate whether a cell or frequency correspond to a TN cell type or an NTN cell type. In some examples, the UE 115-m may prioritize a TN cell or frequency for MBS communications, even if an NTN cell or frequency has a higher signal quality. The neighbor cell list may also indicate a time for which a decryption key associated with a cell or frequency is valid, such that the UE 115-m can prioritize (e.g., select) cells and frequencies based on their respective decryption keys and a capability of the UE 115-m to decode MBS traffic.

At 705, the UE 115-m may receive an indication of prioritization information associated with a first cell (e.g., an NTN cell) and a second cell (e.g., a TN cell). The first cell may correspond to the network entity 105-h (e.g., a satellite, an NTN device), while the second cell may correspond to a different network entity (e.g., a TN entity, a base station). The prioritization information may indicate parameters for prioritizing the first cell or the second cell for MBS communications within a geographic service area (also referred to herein as an MBMS service area or an MBS service area) supported by the first cell and the second cell. In addition to the prioritization information, the UE 115-m may also receive a list of neighbor cells or frequencies (with corresponding network types) and an association (e.g., mapping) between the neighbor cells or frequencies and one or more decryption keys.

At 710, the UE 115-m may determine whether to prioritize the first cell or the second cell for MBS communications based on the prioritization information. In some examples, if the UE 115-m is receiving a portion of an MBS transmission via the first cell, the UE 115-m may determine to prioritize the first cell for a remaining portion of the MBS transmission (e.g., to maintain service continuity). If, for example, the UE 115-m determines to prioritize the first cell for MBS communications, the UE 115-m may perform cell search and selection to begin camping on the first cell. At 715, the UE 115-m may receive an MBS communication via one or both of the first cell or the second cell. At 720, the UE 115-m may decrypt the MBS communication using a decryption key that corresponds to the first cell, the second cell, the geographic service area supported by the first cell and the second cell, or a combination thereof.

The process flow 700 may support techniques for regulating access to MBS communications within a geographic service area. For example, the techniques and operations described with reference to FIG. 7 may enable the network entity 105-h to transmit an encrypted MBS communication to the UE 115-m via an NTN cell. If, for example, the UE 115-m is located within an authorized geographic service area supported by the NTN cell, the network entity 105-h may provide the UE 115-m with a decryption key for the encrypted MBS communication. As such, the UE 115-m may use the decryption key to decode the encrypted MBS communication, while other UEs outside the authorized geographic service area may be unable to decode the encrypted MBS communication. The network entity 105-h may also provide the UE 115-m with additional geographic information, synchronization information, and prioritization information to improve the likelihood of the UE 115-m successfully receiving the encrypted MBS communication (e.g., by enabling the UE 115-m to receive the encrypted MBS communication via multiple cells).

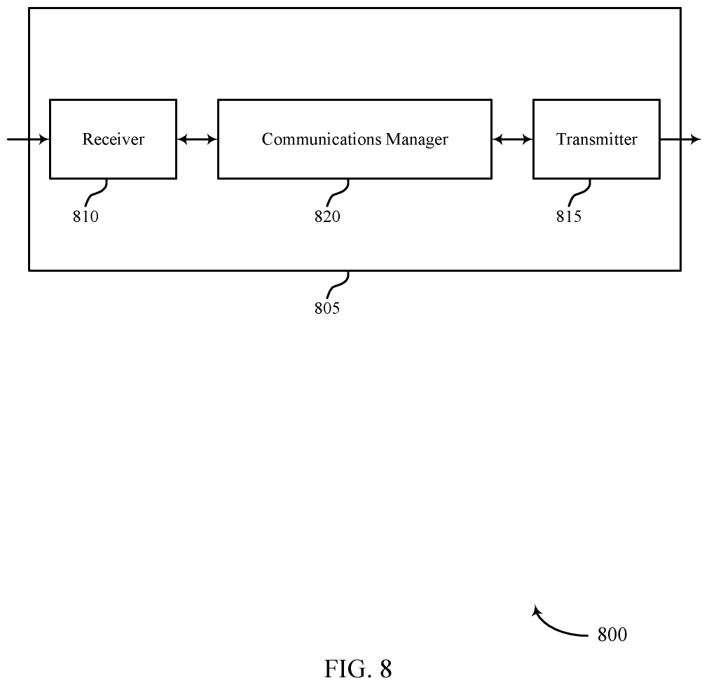

FIG. 8 shows a block diagram 800 of a device 805 that supports broadcast communications for terrestrial and non-terrestrial cells in accordance with one or more aspects of the present disclosure. The device 805 may be an example of aspects of a UE 115, as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to broadcast communications for terrestrial and non-terrestrial cells). Information may be passed on to other components of the device 805. The receiver 810 may utilize a single antenna or multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to broadcast communications for terrestrial and non-terrestrial cells). In some examples, the transmitter 815 may be co-located with a receiver 810 in a transceiver module. The transmitter 815 may utilize a single antenna or multiple antennas.

The communications manager 820, the receiver 810, the transmitter 815, or various combinations thereof or various components thereof may be examples of means for performing various aspects of broadcast communications for terrestrial and non-terrestrial cells, as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations, as described herein.

The communications manager 820 may support wireless communications at the device 805 in accordance with examples disclosed herein. For example, the communications manager 820 may be configured as or otherwise support a means for receiving a control message indicating one or more decryption keys for MBS communications within a geographic service area supported by a cell. The communications manager 820 may be configured as or otherwise support a means for receiving, via the cell, an MBS message within the geographic service area supported by the cell. The communications manager 820 may be configured as or otherwise support a means for decrypting the MBS message using the one or more decryption keys indicated by the control message.

Additionally, or alternatively, the communications manager 820 may support wireless communications at the device 805 in accordance with examples disclosed herein. For example, the communications manager 820 may be configured as or otherwise support a means for receiving an indication of a configuration for a geographic service area supported by a cell, the geographic service area associated with MBS communications, the configuration including geographic information associated with the geographic service area. The communications manager 820 may be configured as or otherwise support a means for receiving an MBS message within the geographic service area supported by the cell based on the geographic information in the configuration.

Additionally, or alternatively, the communications manager 820 may support wireless communications at the device 805 in accordance with examples disclosed herein. For example, the communications manager 820 may be configured as or otherwise support a means for receiving an indication of synchronization information associated with a first cell and a second cell, the first cell and the second cell each supporting MBS communications within a geographic service area. The communications manager 820 may be configured as or otherwise support a means for receiving one or more MBS messages within the geographic service area supported by the first cell and the second cell based on the synchronization information.

Additionally, or alternatively, the communications manager 820 may support wireless communications at the device 805 in accordance with examples disclosed herein. For example, the communications manager 820 may be configured as or otherwise support a means for receiving an indication of prioritization information associated with a first cell and a second cell, the prioritization information indicating one or more parameters for prioritizing the first cell or the second cell for MBS communications within a geographic service area. The communications manager 820 may be configured as or otherwise support a means for receiving, via the first cell and in accordance with the prioritization information, an MBS message within the geographic service area supported by the first cell and the second cell.

By including or configuring the communications manager 820 in accordance with examples described herein, the device 805 (e.g., a processor controlling or otherwise coupled with the receiver 810, the transmitter 815, the communications manager 820, or a combination thereof) may support techniques for reduced power consumption by reducing the number of cell search and selection procedures performed by the device 805 while monitoring for MBS communications.

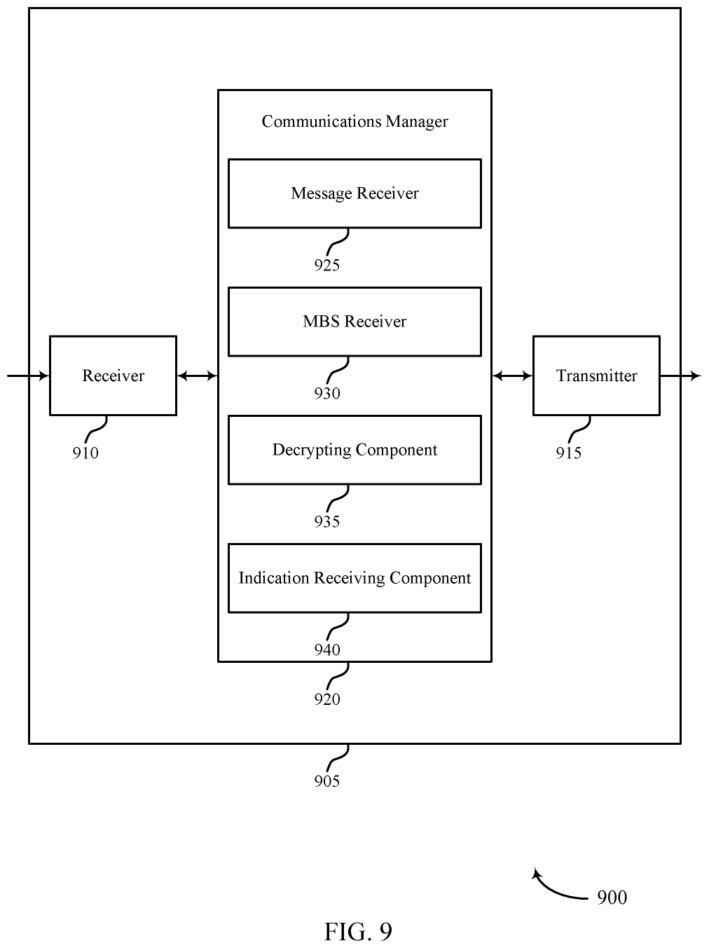

FIG. 9 shows a block diagram 900 of a device 905 that supports broadcast communications for terrestrial and non-terrestrial cells in accordance with one or more aspects of the present disclosure. The device 905 may be an example of aspects of a device 805 or a UE 115, as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to broadcast communications for terrestrial and non-terrestrial cells). Information may be passed on to other components of the device 905. The receiver 910 may utilize a single antenna or multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to broadcast communications for terrestrial and non-terrestrial cells). In some examples, the transmitter 915 may be co-located with a receiver 910 in a transceiver module. The transmitter 915 may utilize a single antenna or multiple antennas.

The device 905, or various components thereof, may be an example of means for performing various aspects of broadcast communications for terrestrial and non-terrestrial cells, as described herein. For example, the communications manager 920 may include a message receiver 925, an MBS receiver 930, a decrypting component 935, an indication receiving component 940, or any combination thereof. The communications manager 920 may be an example of aspects of a communications manager 820, as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations described herein.

The communications manager 920 may support wireless communications at the device 905 in accordance with examples disclosed herein. The message receiver 925 may be configured as or otherwise support a means for receiving a control message indicating one or more decryption keys for MBS communications within a geographic service area supported by a cell. The MBS receiver 930 may be configured as or otherwise support a means for receiving, via the cell, an MBS message within the geographic service area supported by the cell. The decrypting component 935 may be configured as or otherwise support a means for decrypting the MBS message using the one or more decryption keys indicated by the control message.

Additionally, or alternatively, the communications manager 920 may support wireless communications at the device 905 in accordance with examples disclosed herein. The indication receiving component 940 may be configured as or otherwise support a means for receiving an indication of a configuration for a geographic service area supported by a cell, the geographic service area associated with MBS communications, the configuration including geographic information associated with the geographic service area. The MBS receiver 930 may be configured as or otherwise support a means for receiving an MBS message within the geographic service area supported by the cell based on the geographic information in the configuration.

Additionally, or alternatively, the communications manager 920 may support wireless communications at the device 905 in accordance with examples disclosed herein. The indication receiving component 940 may be configured as or otherwise support a means for receiving an indication of synchronization information associated with a first cell and a second cell, the first cell and the second cell each supporting MBS communications within a geographic service area. The MBS receiver 930 may be configured as or otherwise support a means for receiving one or more MBS messages within the geographic service area supported by the first cell and the second cell based on the synchronization information.

Additionally, or alternatively, the communications manager 920 may support wireless communications at the device 905 in accordance with examples disclosed herein. The indication receiving component 940 may be configured as or otherwise support a means for receiving an indication of prioritization information associated with a first cell and a second cell, the prioritization information indicating one or more parameters for prioritizing the first cell or the second cell for MBS communications within a geographic service area. The MBS receiver 930 may be configured as or otherwise support a means for receiving, via the first cell and in accordance with the prioritization information, an MBS message within the geographic service area supported by the first cell and the second cell.

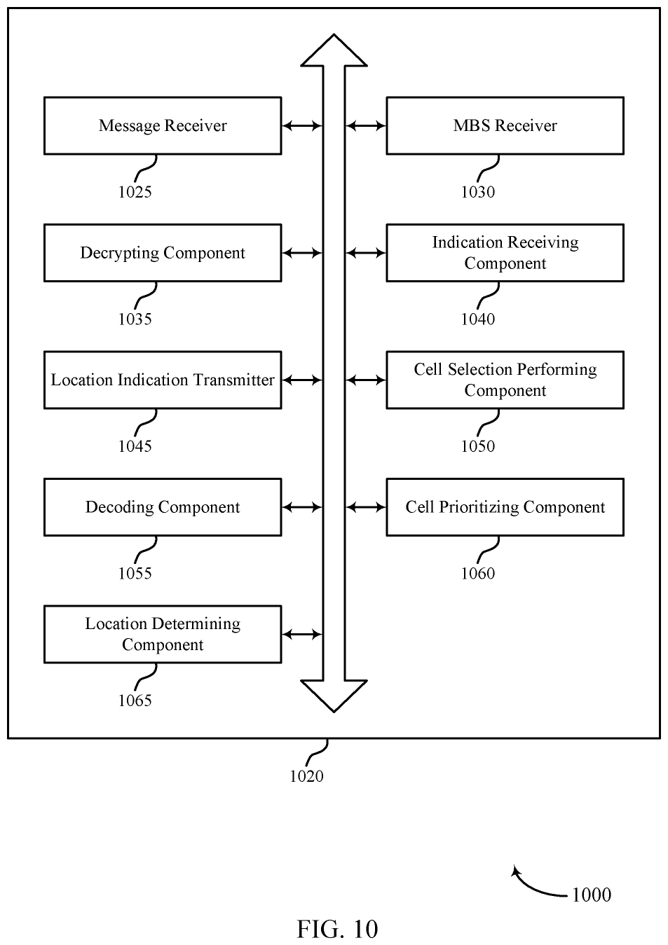

FIG. 10 shows a block diagram 1000 of a communications manager 1020 that supports broadcast communications for terrestrial and non-terrestrial cells in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of broadcast communications for terrestrial and non-terrestrial cells, as described herein. For example, the communications manager 1020 may include a message receiver 1025, an MBS receiver 1030, a decrypting component 1035, an indication receiving component 1040, a location indication transmitter 1045, a cell selection performing component 1050, a decoding component 1055, a cell prioritizing component 1060, a location determining component 1065, or any combination thereof. Each of these components may communicate, directly or indirectly, with one another (e.g., via one or more buses).

The communications manager 1020 may support wireless communications at a UE in accordance with examples disclosed herein. The message receiver 1025 may be configured as or otherwise support a means for receiving a control message indicating one or more decryption keys for MBS communications within a geographic service area supported by a cell. The MBS receiver 1030 may be configured as or otherwise support a means for receiving, via the cell, an MBS message within the geographic service area supported by the cell. The decrypting component 1035 may be configured as or otherwise support a means for decrypting the MBS message using the one or more decryption keys indicated by the control message.

In some examples, the indication receiving component 1040 may be configured as or otherwise support a means for receiving an indication of multiple decryption keys for multiple geographic service areas supported by the cell. In some examples, the decrypting component 1035 may be configured as or otherwise support a means for selecting the one or more decryption keys from the multiple decryption keys based on the geographic service area. In some examples, the multiple decryption keys include time-variant decryption keys that are based on a geographic location of the cell.

In some examples, the decrypting component 1035 may be configured as or otherwise support a means for generating the one or more decryption keys based on an identifier of the cell, an index associated with a geographic location of the UE, a beam index, a tracking area, a key value, a counter value, or a combination thereof.

In some examples, the location indication transmitter 1045 may be configured as or otherwise support a means for transmitting an indication of a geographic location of the UE, where receiving the control message is based on the geographic location of the UE corresponding to the geographic service area supported by the cell.

In some examples, the MBS message includes multicast control data, multicast traffic data, or both. In some examples, the multicast control data indicates that the multicast traffic data is encrypted. In some examples, receiving the MBS message is based on an encryption status of the multicast traffic data and on a determination that the one or more decryption keys are valid for the MBS message. In some examples, the multicast control data indicates that an encryption key used for encrypting the multicast traffic data has changed within a time period.

In some examples, the message receiver 1025 may be configured as or otherwise support a means for receiving a paging message indicating that an encryption key used for encrypting the multicast traffic data has changed. In some examples, the multicast control data indicates an index associated with an encryption key used for encrypting the multicast traffic data.

In some examples, the location determining component 1065 may be configured as or otherwise support a means for determining that the UE has moved to a second geographic service area that is different from the geographic service area supported by the cell. In some examples, the decrypting component 1035 may be configured as or otherwise support a means for decrypting the multicast traffic data using a decryption key that is based on a tracking area associated with the second geographic service area, an index associated with the second geographic service area, or both.

Additionally, or alternatively, the communications manager 1020 may support wireless communications at a UE in accordance with examples disclosed herein. The indication receiving component 1040 may be configured as or otherwise support a means for receiving an indication of a configuration for a geographic service area supported by a cell, the geographic service area associated with MBS communications, the configuration including geographic information associated with the geographic service area. In some examples, the MBS receiver 1030 may be configured as or otherwise support a means for receiving an MBS message within the geographic service area supported by the cell based on the geographic information in the configuration.

In some examples, the decrypting component 1035 may be configured as or otherwise support a means for decrypting the MBS message using a decryption key that is based on the configuration for the geographic service area.

In some examples, to support receiving the indication, the indication receiving component 1040 may be configured as or otherwise support a means for receiving dedicated signaling or a broadcast message that indicates one or more tracking areas, cell identifiers, or frequencies associated with the geographic service area.

In some examples, the indication receiving component 1040 may be configured as or otherwise support a means for receiving a message that indicates an association between multiple TACs and multiple tracking areas within the geographic service area supported by the cell. In some examples, the cell selection performing component 1050 may be configured as or otherwise support a means for performing a cell selection procedure based on the association, a tracking area of the UE, a set of cells corresponding to the tracking area of the UE, a set of frequencies corresponding to the tracking area of the UE, or a combination thereof.

In some examples, to support receiving the indication, the message receiver 1025 may be configured as or otherwise support a means for receiving a message that indicates a time duration for which the configuration of the geographic service area is valid, the configuration including a list of frequencies or cells associated with the geographic service area.

In some examples, the cell selection performing component 1050 may be configured as or otherwise support a means for performing a cell selection procedure based on a tracking area of the UE, the configuration for the geographic service area supported by the cell, and a time duration for which the configuration is valid.

In some examples, to support receiving the indication, the message receiver 1025 may be configured as or otherwise support a means for receiving, via a serving cell of the UE or a previous serving cell of the UE, a broadcast message indicating a list of tracking areas associated with the geographic service area.

In some examples, the message receiver 1025 may be configured as or otherwise support a means for receiving a NAS message or an RRC message that indicates geo-fencing information associated with the geographic service area supported by the cell. In some examples, the cell selection performing component 1050 may be configured as or otherwise support a means for performing a cell selection procedure based on the geo-fencing information, the configuration of the geographic service area, or both.

Additionally, or alternatively, the communications manager 1020 may support wireless communications at a UE in accordance with examples disclosed herein. In some examples, the indication receiving component 1040 may be configured as or otherwise support a means for receiving an indication of synchronization information associated with a first cell and a second cell, the first cell and the second cell each supporting MBS communications within a geographic service area. In some examples, the MBS receiver 1030 may be configured as or otherwise support a means for receiving one or more MBS messages within the geographic service area supported by the first cell and the second cell based on the synchronization information.

In some examples, the decoding component 1055 may be configured as or otherwise support a means for decoding the one or more MBS messages based on the synchronization information.

In some examples, to support receiving the one or more MBS messages, the MBS receiver 1030 may be configured as or otherwise support a means for receiving the one or more MBS messages via one or both of the first cell or the second cell based on a signal quality associated with the first cell, a signal quality associated with the second cell, or both.

In some examples, to support receiving the one or more MBS messages, the MBS receiver 1030 may be configured as or otherwise support a means for receiving the one or more MBS messages via one or both of the first cell or the second cell while the UE is operating in a receive-only mode.

In some examples, to support receiving the one or more MBS messages, the MBS receiver 1030 may be configured as or otherwise support a means for receiving the one or more MBS messages via one or both of the first cell or the second cell based on the first cell or the second cell applying a delay offset to the one or more MBS messages.

In some examples, the message receiver 1025 may be configured as or otherwise support a means for receiving a message that indicates the delay offset. In some examples, the decoding component 1055 may be configured as or otherwise support a means for decoding at least a portion of the one or more MBS messages based on the delay offset, where one or both of the first cell or the second cell are associated with a non-terrestrial network or a terrestrial network.

Additionally, or alternatively, the communications manager 1020 may support wireless communications at a UE in accordance with examples disclosed herein. In some examples, the indication receiving component 1040 may be configured as or otherwise support a means for receiving an indication of prioritization information associated with a first cell and a second cell, the prioritization information indicating one or more parameters for prioritizing the first cell or the second cell for MBS communications within a geographic service area. In some examples, the MBS receiver 1030 may be configured as or otherwise support a means for receiving, via the first cell and in accordance with the prioritization information, an MBS message within the geographic service area supported by the first cell and the second cell.

In some examples, the decrypting component 1035 may be configured as or otherwise support a means for decrypting the MBS message using a decryption key that corresponds to the first cell. In some examples, to support receiving the MBS message, the MBS receiver 1030 may be configured as or otherwise support a means for receiving a first portion of the MBS message via the first cell. In some examples, to support receiving the MBS message, the cell prioritizing component 1060 may be configured as or otherwise support a means for determining to prioritize the first cell for reception of a remaining portion of the MBS message.

In some examples, the message receiver 1025 may be configured as or otherwise support a means for receiving a multicast control message indicating a set of cells that support the geographic service area and a network type associated with the set of cells. In some examples, the cell prioritizing component 1060 may be configured as or otherwise support a means for determining to prioritize the first cell for reception of the MBS message based on the prioritization information, information in the multicast control message including geographic area and network type, or both.

In some examples, the message receiver 1025 may be configured as or otherwise support a means for receiving a multicast control message indicating an association between one or more decryption keys and one or more cells or frequencies associated with the geographic service area, a time duration for which the association is valid, or both. In some examples, the cell prioritizing component 1060 may be configured as or otherwise support a means for determining to prioritize the first cell or the second cell for reception of MBS communications based on the multicast control message, a capability of the UE to decode MBS communications within the geographic service area, or both.

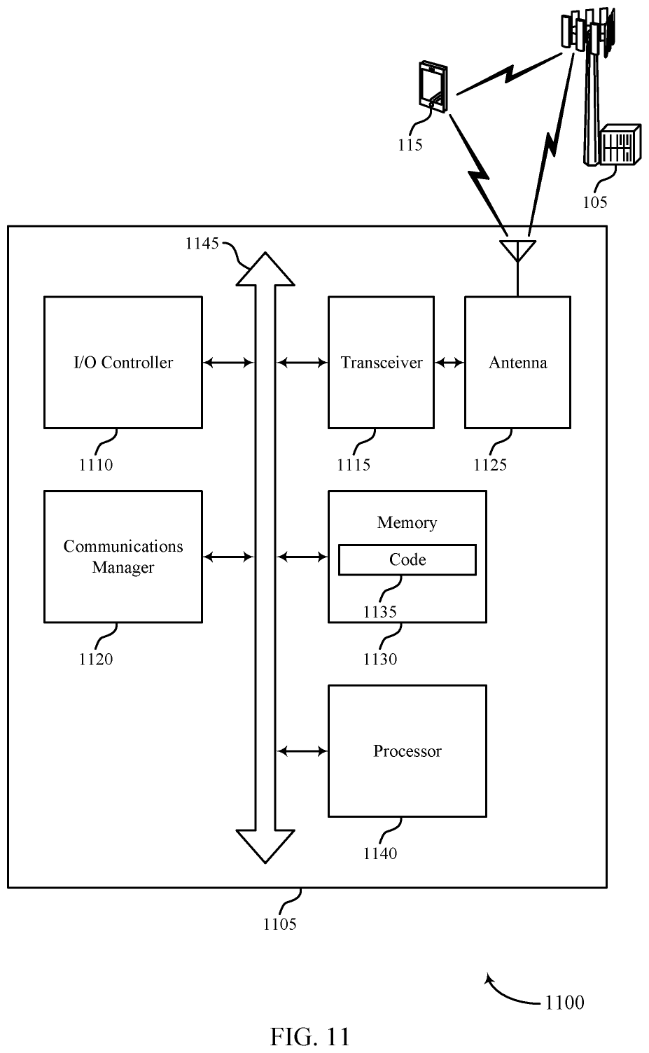

FIG. 11 shows a diagram of a system 1100 including a device 1105 that supports broadcast communications for terrestrial and non-terrestrial cells in accordance with one or more aspects of the present disclosure. The device 1105 may be an example of or include the components of a device 805, a device 905, or a UE 115, as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals separate from the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links, as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may be indirectly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting broadcast communications for terrestrial and non-terrestrial cells). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communications at the device 1105 in accordance with examples disclosed herein. For example, the communications manager 1120 may be configured as or otherwise support a means for receiving a control message indicating one or more decryption keys for MBS communications within a geographic service area supported by a cell. The communications manager 1120 may be configured as or otherwise support a means for receiving, via the cell, an MBS message within the geographic service area supported by the cell. The communications manager 1120 may be configured as or otherwise support a means for decrypting the MBS message using the one or more decryption keys indicated by the control message.

Additionally, or alternatively, the communications manager 1120 may support wireless communications at the device 1105 in accordance with examples disclosed herein. For example, the communications manager 1120 may be configured as or otherwise support a means for receiving an indication of a configuration for a geographic service area supported by a cell, the geographic service area associated with MBS communications, the configuration including geographic information associated with the geographic service area. The communications manager 1120 may be configured as or otherwise support a means for receiving an MBS message within the geographic service area supported by the cell based on the geographic information in the configuration.

Additionally, or alternatively, the communications manager 1120 may support wireless communications at the device 1105 in accordance with examples disclosed herein. For example, the communications manager 1120 may be configured as or otherwise support a means for receiving an indication of synchronization information associated with a first cell and a second cell, the first cell and the second cell each supporting MBS communications within a geographic service area. The communications manager 1120 may be configured as or otherwise support a means for receiving one or more MBS messages within the geographic service area supported by the first cell and the second cell based on the synchronization information.

Additionally, or alternatively, the communications manager 1120 may support wireless communications at the device 1105 in accordance with examples disclosed herein. For example, the communications manager 1120 may be configured as or otherwise support a means for receiving an indication of prioritization information associated with a first cell and a second cell, the prioritization information indicating one or more parameters for prioritizing the first cell or the second cell for MBS communications within a geographic service area. The communications manager 1120 may be configured as or otherwise support a means for receiving, via the first cell and in accordance with the prioritization information, an MBS message within the geographic service area supported by the first cell and the second cell.

By including or configuring the communications manager 1120 in accordance with examples described herein, the device 1105 may support techniques for regulating access to MBS communications within a geographic service area. For example, the techniques and operations described herein may enable a network entity to regulate which UEs can receive MBS communications from the network entity by encrypting some or all of the MBS communications and providing the device 1105 (e.g., a UE in an authorized geographic service area of the network entity) with a corresponding decryption key. The device 1105 may use the decryption key provided by the network entity to decrypt the MBS communications, while unauthorized UEs (e.g., UEs outside an authorized geographic service area of the network entity) may be unable to decrypt the MBS communications. The techniques described herein may also enable the device 1105 to perform cell search and selection with greater efficiency, which may increase the likelihood of the device 1105 successfully receiving MBS communications from the network entity.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of broadcast communications for terrestrial and non-terrestrial cells, as described herein, or the processor 1140 and the memory 1130 may be otherwise configured to perform or support such operations.

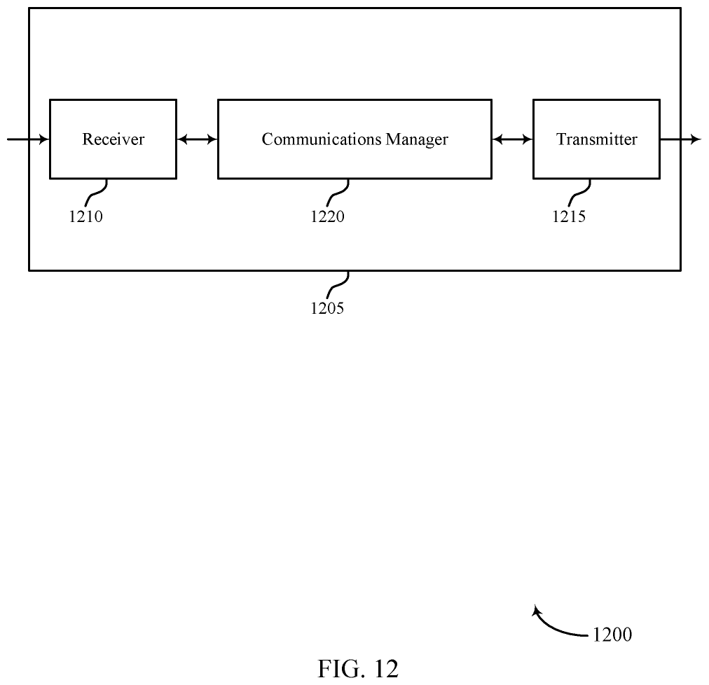

FIG. 12 shows a block diagram 1200 of a device 1205 that supports broadcast communications for terrestrial and non-terrestrial cells in accordance with one or more aspects of the present disclosure. The device 1205 may be an example of aspects of a network entity 105, as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of broadcast communications for terrestrial and non-terrestrial cells, as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations described herein.

The communications manager 1220 may support wireless communications at the device 1205 in accordance with examples disclosed herein. For example, the communications manager 1220 may be configured as or otherwise support a means for outputting a control message indicating one or more decryption keys for MBS communications within a geographic service area supported by a cell. The communications manager 1220 may be configured as or otherwise support a means for encrypting an MBS message using an encryption key that corresponds to the one or more decryption keys indicated by the control message. The communications manager 1220 may be configured as or otherwise support a means for outputting, via the cell, the MBS message within the geographic service area supported by the cell.

Additionally, or alternatively, the communications manager 1220 may support wireless communications at the device 1205 in accordance with examples disclosed herein. For example, the communications manager 1220 may be configured as or otherwise support a means for outputting an indication of a configuration for a geographic service area supported by a cell, the geographic service area associated with MBS communications, the configuration including geographic information associated with the geographic service area. The communications manager 1220 may be configured as or otherwise support a means for outputting an MBS message within the geographic service area supported by the cell based on the geographic information in the configuration.

Additionally, or alternatively, the communications manager 1220 may support wireless communications at the device 1205 in accordance with examples disclosed herein. For example, the communications manager 1220 may be configured as or otherwise support a means for outputting an indication of synchronization information associated with a first cell and a second cell, the first cell and the second cell each supporting MBS communications within a geographic service area. The communications manager 1220 may be configured as or otherwise support a means for outputting one or more MBS messages within the geographic service area supported by the first cell and the second cell based on the synchronization information.

Additionally, or alternatively, the communications manager 1220 may support wireless communications at the device 1205 in accordance with examples disclosed herein. For example, the communications manager 1220 may be configured as or otherwise support a means for outputting an indication of prioritization information associated with a first cell and a second cell, the prioritization information indicating one or more parameters for prioritizing the first cell or the second cell for MBS communications within a geographic service area. The communications manager 1220 may be configured as or otherwise support a means for outputting, via the first cell, an MBS message within the geographic service area supported by the first cell and the second cell.

By including or configuring the communications manager 1220 in accordance with examples described herein, the device 1205 (e.g., a processor controlling or otherwise coupled with the receiver 1210, the transmitter 1215, the communications manager 1220, or a combination thereof) may support techniques for more efficient utilization of communication resources by regulating which UEs can receive and decode MBS communications from the device 1205.

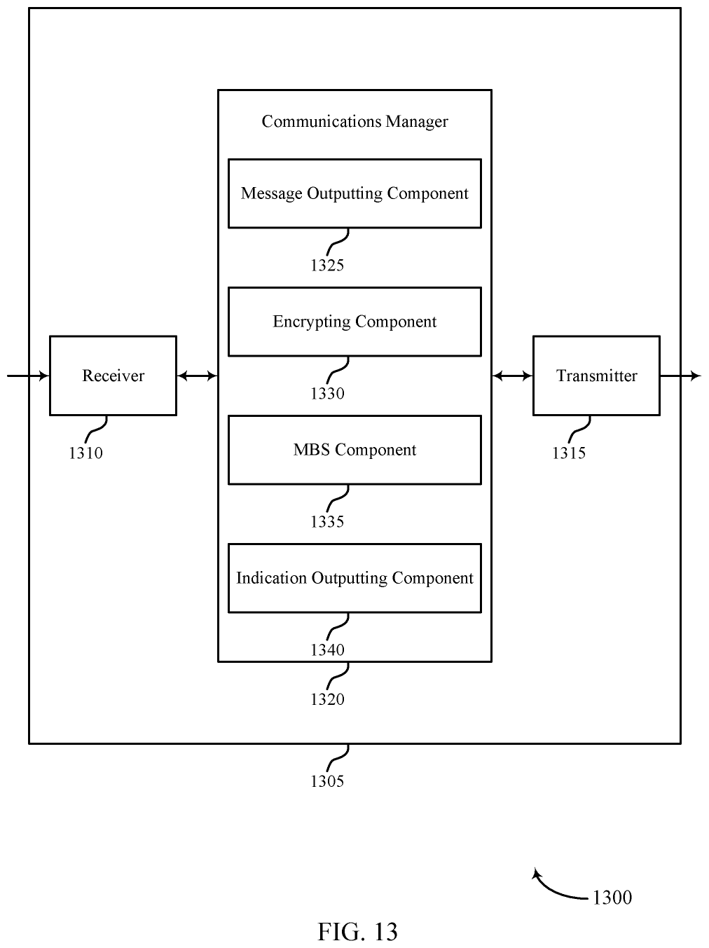

FIG. 13 shows a block diagram 1300 of a device 1305 that supports broadcast communications for terrestrial and non-terrestrial cells in accordance with one or more aspects of the present disclosure. The device 1305 may be an example of aspects of a device 1205 or a network entity 105, as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of broadcast communications for terrestrial and non-terrestrial cells, as described herein. For example, the communications manager 1320 may include a message outputting component 1325, an encrypting component 1330, an MBS component 1335, an indication outputting component 1340, or any combination thereof. The communications manager 1320 may be an example of aspects of a communications manager 1220, as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations described herein.

The communications manager 1320 may support wireless communications at the device 1305 in accordance with examples disclosed herein. The message outputting component 1325 may be configured as or otherwise support a means for outputting a control message indicating one or more decryption keys for MBS communications within a geographic service area supported by a cell. The encrypting component 1330 may be configured as or otherwise support a means for encrypting an MBS message using an encryption key that corresponds to the one or more decryption keys indicated by the control message. The MBS component 1335 may be configured as or otherwise support a means for outputting, via the cell, the MBS message within the geographic service area supported by the cell.

Additionally, or alternatively, the communications manager 1320 may support wireless communications at the device 1305 in accordance with examples disclosed herein. The indication outputting component 1340 may be configured as or otherwise support a means for outputting an indication of a configuration for a geographic service area supported by a cell, the geographic service area associated with MBS communications, the configuration including geographic information associated with the geographic service area. The MBS component 1335 may be configured as or otherwise support a means for outputting an MBS message within the geographic service area supported by the cell based on the geographic information in the configuration.

Additionally, or alternatively, the communications manager 1320 may support wireless communications at the device 1305 in accordance with examples disclosed herein. The indication outputting component 1340 may be configured as or otherwise support a means for outputting an indication of synchronization information associated with a first cell and a second cell, the first cell and the second cell each supporting MBS communications within a geographic service area. The MBS component 1335 may be configured as or otherwise support a means for outputting one or more MBS messages within the geographic service area supported by the first cell and the second cell based on the synchronization information.

Additionally, or alternatively, the communications manager 1320 may support wireless communications at the device 1305 in accordance with examples disclosed herein. The indication outputting component 1340 may be configured as or otherwise support a means for outputting an indication of prioritization information associated with a first cell and a second cell, the prioritization information indicating one or more parameters for prioritizing the first cell or the second cell for MBS communications within a geographic service area. The MBS component 1335 may be configured as or otherwise support a means for outputting, via the first cell, an MBS message within the geographic service area supported by the first cell and the second cell.

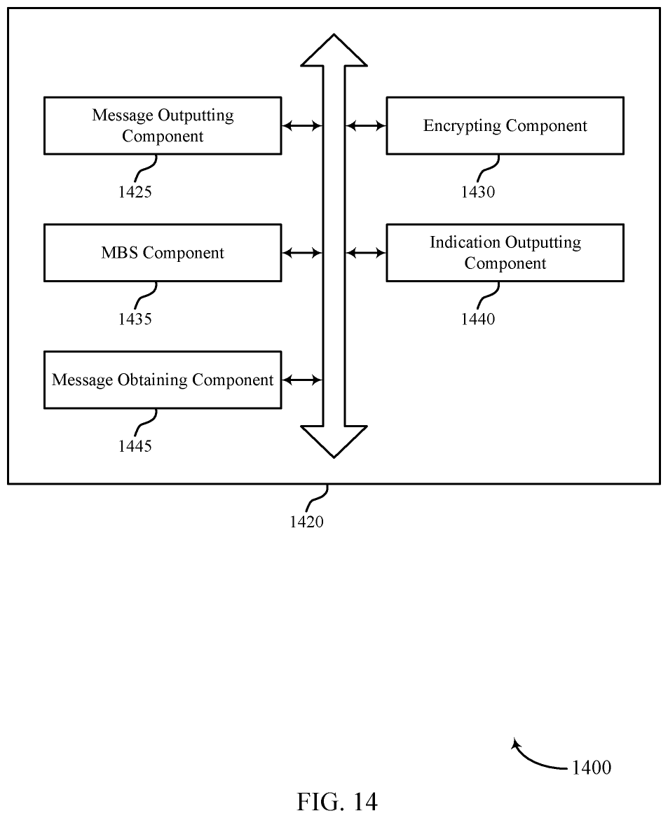

FIG. 14 shows a block diagram 1400 of a communications manager 1420 that supports broadcast communications for terrestrial and non-terrestrial cells in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of broadcast communications for terrestrial and non-terrestrial cells, as described herein. For example, the communications manager 1420 may include a message outputting component 1425, an encrypting component 1430, an MBS component 1435, an indication outputting component 1440, a message obtaining component 1445, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communications at a network entity in accordance with examples disclosed herein. The message outputting component 1425 may be configured as or otherwise support a means for outputting a control message indicating one or more decryption keys for MBS communications within a geographic service area supported by a cell. The encrypting component 1430 may be configured as or otherwise support a means for encrypting an MBS message using an encryption key that corresponds to the one or more decryption keys indicated by the control message. The MBS component 1435 may be configured as or otherwise support a means for outputting, via the cell, the MBS message within the geographic service area supported by the cell.

In some examples, the indication outputting component 1440 may be configured as or otherwise support a means for outputting an indication of multiple decryption keys for multiple geographic service areas supported by the cell, the multiple decryption keys including the one or more decryption keys indicated by the control message. In some examples, the multiple decryption keys include time-variant decryption keys that are based on a geographic location of the cell.

In some examples, the encrypting component 1430 may be configured as or otherwise support a means for generating the one or more decryption keys based on an identifier of the cell, an index associated with a geographic location, a beam index, a tracking area, a key value, a counter value, or a combination thereof.

In some examples, the message obtaining component 1445 may be configured as or otherwise support a means for obtaining a first message that indicates a geographic location of a UE. In some examples, the message outputting component 1425 may be configured as or otherwise support a means for outputting a second message that indicates one or more decryption keys for MBS communications that are applicable to the geographic location of the UE.

In some examples, the MBS message include multicast control data, multicast traffic data, or both. In some examples, the multicast control data indicates that the multicast traffic data is encrypted. In some examples, the multicast control data indicates that the encryption key used for encrypting the multicast traffic data has changed within a time period. In some examples, the multicast control data indicates an index associated with the encryption key used for encrypting the multicast traffic data. In some examples, the one or more decryption keys correspond to a tracking area associated with the geographic service area, an index associated with the geographic service area, or both.

In some examples, the message outputting component 1425 may be configured as or otherwise support a means for outputting a paging message indicating that the encryption key used for encrypting the multicast traffic data has changed.

Additionally, or alternatively, the communications manager 1420 may support wireless communications at a network entity in accordance with examples disclosed herein. The indication outputting component 1440 may be configured as or otherwise support a means for outputting an indication of a configuration for a geographic service area supported by a cell, the geographic service area associated with MBS communications, the configuration including geographic information associated with the geographic service area. In some examples, the MBS component 1435 may be configured as or otherwise support a means for outputting an MBS message within the geographic service area supported by the cell based on the geographic information in the configuration.

In some examples, the encrypting component 1430 may be configured as or otherwise support a means for encrypting the MBS message using an encryption key that is based on the configuration for the geographic service area.

In some examples, to support outputting the indication, the message outputting component 1425 may be configured as or otherwise support a means for outputting dedicated signaling or a broadcast message that indicates one or more tracking areas, cell identifiers, or frequencies associated with the geographic service area.

In some examples, to support outputting the indication, the message outputting component 1425 may be configured as or otherwise support a means for outputting a message that indicates an association between multiple TACs and multiple tracking areas within the geographic service area supported by the cell.

In some examples, to support outputting the indication, the message outputting component 1425 may be configured as or otherwise support a means for outputting a message that indicates a time duration for which the configuration of the geographic service area is valid, the configuration including a list of frequencies or cells associated with the geographic service area.

In some examples, to support outputting the indication, the message outputting component 1425 may be configured as or otherwise support a means for outputting a broadcast message indicating a list of tracking areas associated with the geographic service area.

In some examples, the message outputting component 1425 may be configured as or otherwise support a means for outputting a NAS message or an RRC message indicating geo-fencing information associated with the geographic service area supported by the cell.

Additionally, or alternatively, the communications manager 1420 may support wireless communications at a network entity in accordance with examples disclosed herein. In some examples, the indication outputting component 1440 may be configured as or otherwise support a means for outputting an indication of synchronization information associated with a first cell and a second cell, the first cell and the second cell each supporting MBS communications within a geographic service area. In some examples, the MBS component 1435 may be configured as or otherwise support a means for outputting one or more MBS messages within the geographic service area supported by the first cell and the second cell based on the synchronization information.

In some examples, the encrypting component 1430 may be configured as or otherwise support a means for encrypting the one or more MBS messages using an encryption key associated with the first cell, the second cell, the geographic service area, or a combination thereof.

In some examples, to support outputting the one or more MBS messages, the MBS component 1435 may be configured as or otherwise support a means for outputting the one or more MBS messages with a delay offset that corresponds to a propagation delay between the first cell and the second cell.

In some examples, the message outputting component 1425 may be configured as or otherwise support a means for outputting a message that indicates the delay offset prior to transmission of the one or more MBS messages.

Additionally, or alternatively, the communications manager 1420 may support wireless communications at a network entity in accordance with examples disclosed herein. In some examples, the indication outputting component 1440 may be configured as or otherwise support a means for outputting an indication of prioritization information associated with a first cell and a second cell, the prioritization information indicating one or more parameters for prioritizing the first cell or the second cell for MBS communications within a geographic service area. In some examples, the MBS component 1435 may be configured as or otherwise support a means for outputting, via the first cell, an MBS message within the geographic service area supported by the first cell and the second cell.

In some examples, the encrypting component 1430 may be configured as or otherwise support a means for encrypting the MBS message using an encryption key that corresponds to the first cell.

In some examples, the message outputting component 1425 may be configured as or otherwise support a means for outputting a multicast control message indicating a set of cells that support the geographic service area and a network type associated with the set of cells.

In some examples, the message outputting component 1425 may be configured as or otherwise support a means for outputting a multicast control message indicating an association between one or more decryption keys and one or more cells or frequencies associated with the geographic service area, a time duration for which the association is valid, or both.

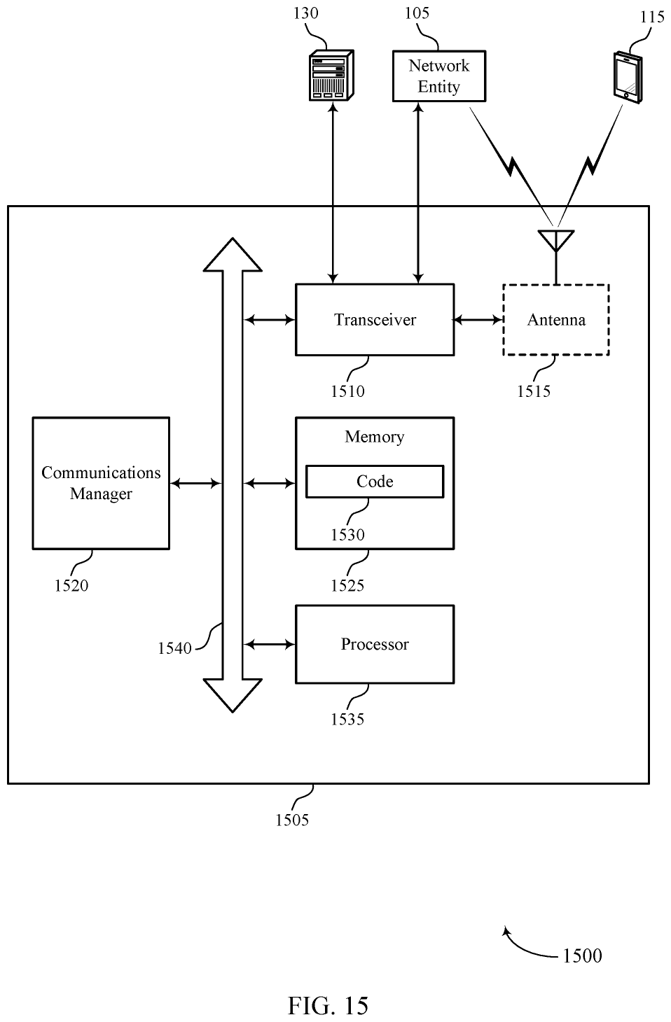

FIG. 15 shows a diagram of a system 1500 including a device 1505 that supports broadcast communications for terrestrial and non-terrestrial cells in accordance with one or more aspects of the present disclosure. The device 1505 may be an example of or include the components of a device 1205, a device 1305, or a network entity 105, as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, a memory 1525, code 1530, and a processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both, as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. The transceiver 1510, or the transceiver 1510 and one or more antennas 1515 or wired interfaces, where applicable, may be an example of a transmitter 1215, a transmitter 1315, a receiver 1210, a receiver 1310, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1525 may include RAM and ROM. The memory 1525 may store computer-readable, computer-executable code 1530 including instructions that, when executed by the processor 1535, cause the device 1505 to perform various functions described herein. The code 1530 may be stored in a non-transitory computer-readable medium such as system memory or another type of memory. In some cases, the code 1530 may be indirectly executable by the processor 1535 but may cause a computer (e.g., when compiled and executed) to perform functions described herein. In some cases, the memory 1525 may contain, among other things, a BIOS which may control basic hardware or software operation such as the interaction with peripheral components or devices.

The processor 1535 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1535 may be configured to operate a memory array using a memory controller. In some other cases, a memory controller may be integrated into the processor 1535. The processor 1535 may be configured to execute computer-readable instructions stored in a memory (e.g., the memory 1525) to cause the device 1505 to perform various functions (e.g., functions or tasks supporting broadcast communications for terrestrial and non-terrestrial cells). For example, the device 1505 or a component of the device 1505 may include a processor 1535 and memory 1525 coupled with the processor 1535, the processor 1535 and memory 1525 configured to perform various functions described herein. The processor 1535 may be an example of a cloud-computing platform (e.g., one or more physical nodes and supporting software such as operating systems, virtual machines, or container instances) that may host the functions (e.g., by executing code 1530) to perform the functions of the device 1505.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the memory 1525, the code 1530, and the processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

The communications manager 1520 may support wireless communications at the device 1505 in accordance with examples disclosed herein. For example, the communications manager 1520 may be configured as or otherwise support a means for outputting a control message indicating one or more decryption keys for MBS communications within a geographic service area supported by a cell. The communications manager 1520 may be configured as or otherwise support a means for encrypting an MBS message using an encryption key that corresponds to the one or more decryption keys indicated by the control message. The communications manager 1520 may be configured as or otherwise support a means for outputting, via the cell, the MBS message within the geographic service area supported by the cell.

Additionally, or alternatively, the communications manager 1520 may support wireless communications at the device 1505 in accordance with examples disclosed herein. For example, the communications manager 1520 may be configured as or otherwise support a means for outputting an indication of a configuration for a geographic service area supported by a cell, the geographic service area associated with MBS communications, the configuration including geographic information associated with the geographic service area. The communications manager 1520 may be configured as or otherwise support a means for outputting an MBS message within the geographic service area supported by the cell based on the geographic information in the configuration.

Additionally, or alternatively, the communications manager 1520 may support wireless communications at the device 1505 in accordance with examples disclosed herein. For example, the communications manager 1520 may be configured as or otherwise support a means for outputting an indication of synchronization information associated with a first cell and a second cell, the first cell and the second cell each supporting MBS communications within a geographic service area. The communications manager 1520 may be configured as or otherwise support a means for outputting one or more MBS messages within the geographic service area supported by the first cell and the second cell based on the synchronization information.

Additionally, or alternatively, the communications manager 1520 may support wireless communications at the device 1505 in accordance with examples disclosed herein. For example, the communications manager 1520 may be configured as or otherwise support a means for outputting an indication of prioritization information associated with a first cell and a second cell, the prioritization information indicating one or more parameters for prioritizing the first cell or the second cell for MBS communications within a geographic service area. The communications manager 1520 may be configured as or otherwise support a means for outputting, via the first cell, an MBS message within the geographic service area supported by the first cell and the second cell.

By including or configuring the communications manager 1520 in accordance with examples described herein, the device 1505 may support techniques for regulating access to MBS communications within a geographic service area. For example, the techniques and operations described herein may enable the device 1505 to regulate which UEs can receive MBS communications from the device 1505 by encrypting some or all of the MBS communications and providing authorized UEs (e.g., UEs in an authorized geographic service area of the device 1505) with a corresponding decryption key. The authorized UEs may use the decryption key provided by the device 1505 to decrypt the MBS communications, while unauthorized UEs (e.g., UEs outside an authorized geographic service area of the device 1505) may be unable to decrypt the MBS communications. The techniques described herein may also enable the authorized UEs to perform cell search and selection with greater efficiency, which may increase the likelihood of the authorized UEs successfully receiving MBS communications from the device 1505.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the processor 1535, the memory 1525, the code 1530, the transceiver 1510, or any combination thereof. For example, the code 1530 may include instructions executable by the processor 1535 to cause the device 1505 to perform various aspects of broadcast communications for terrestrial and non-terrestrial cells, as described herein, or the processor 1535 and the memory 1525 may be otherwise configured to perform or support such operations.

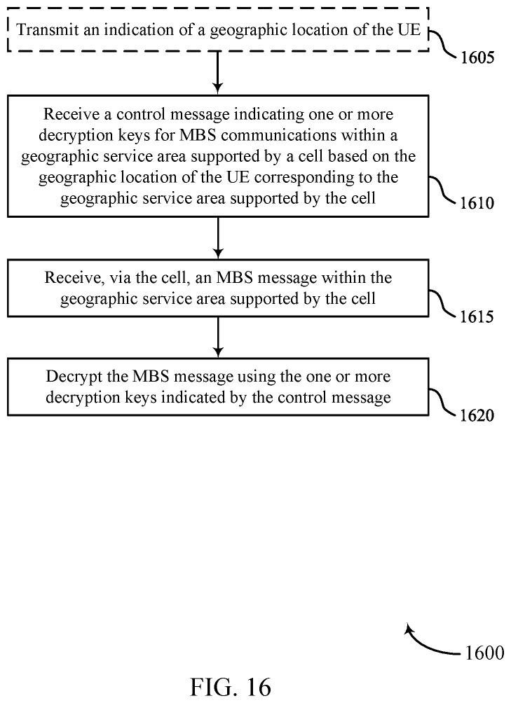

FIG. 16 shows a flowchart illustrating a method 1600 that supports broadcast communications for terrestrial and non-terrestrial cells in accordance with one or more aspects of the present disclosure. The operations of the method 1600 may be implemented by a UE or components of a UE, as described herein. For example, the operations of the method 1600 may be performed by a UE 115, as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include transmitting an indication of a geographic location of the UE. The operations of 1605 may be performed in accordance with examples disclosed herein. In some examples, aspects of the operations of 1605 may be performed by a location indication transmitter 1045, as described with reference to FIG. 10.

At 1610, the method may include receiving a control message indicating one or more decryption keys for MBS communications within a geographic service area supported by a cell based on the geographic location of the UE corresponding to the geographic service area supported by the cell. The operations of 1610 may be performed in accordance with examples disclosed herein. In some examples, aspects of the operations of 1610 may be performed by a message receiver 1025, as described with reference to FIG. 10.

At 1615, the method may include receiving, via the cell, an MBS message within the geographic service area supported by the cell. The operations of 1615 may be performed in accordance with examples disclosed herein. In some examples, aspects of the operations of 1615 may be performed by an MBS receiver 1030, as described with reference to FIG. 10.

At 1620, the method may include decrypting the MBS message using the one or more decryption keys indicated by the control message. The operations of 1620 may be performed in accordance with examples disclosed herein. In some examples, aspects of the operations of 1620 may be performed by a decrypting component 1035, as described with reference to FIG. 10.

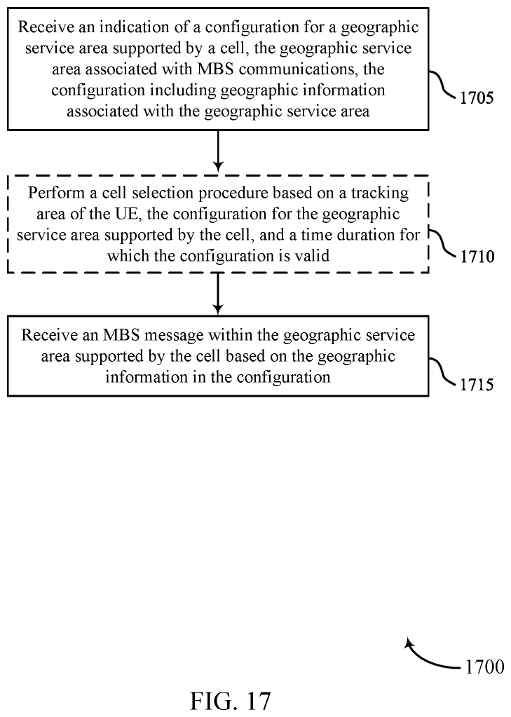

FIG. 17 shows a flowchart illustrating a method 1700 that supports broadcast communications for terrestrial and non-terrestrial cells in accordance with one or more aspects of the present disclosure. The operations of the method 1700 may be implemented by a UE or components of a UE, as described herein. For example, the operations of the method 1700 may be performed by a UE 115, as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include receiving an indication of a configuration for a geographic service area supported by a cell, the geographic service area associated with MBS communications, the configuration including geographic information associated with the geographic service area. The operations of 1705 may be performed in accordance with examples disclosed herein. In some examples, aspects of the operations of 1705 may be performed by an indication receiving component 1040, as described with reference to FIG. 10.

At 1710, the method may include performing a cell selection procedure based on a tracking area of the UE, the configuration for the geographic service area supported by the cell, and a time duration for which the configuration is valid. The operations of 1710 may be performed in accordance with examples disclosed herein. In some examples, aspects of the operations of 1710 may be performed by a cell selection performing component 1050, as described with reference to FIG. 10.

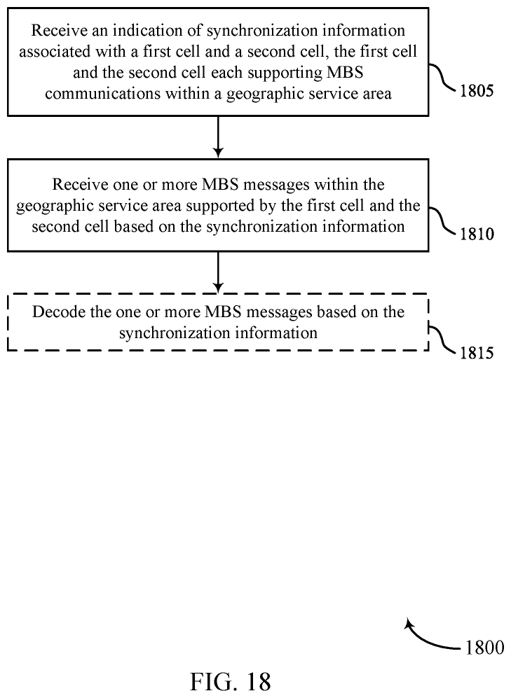

At 1715, the method may include receiving an MBS message within the geographic service area supported by the cell based on the geographic information in the configuration. The operations of 1715 may be performed in accordance with examples disclosed herein. In some examples, aspects of the operations of 1715 may be performed by an MBS receiver 1030, as described with reference to FIG. 10. FIG. 18 shows a flowchart illustrating a method 1800 that supports

broadcast communications for terrestrial and non-terrestrial cells in accordance with one or more aspects of the present disclosure. The operations of the method 1800 may be implemented by a UE or components of a UE, as described herein. For example, the operations of the method 1800 may be performed by a UE 115, as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1805, the method may include receiving an indication of synchronization information associated with a first cell and a second cell, the first cell and the second cell each supporting MBS communications within a geographic service area. The operations of 1805 may be performed in accordance with examples disclosed herein. In some examples, aspects of the operations of 1805 may be performed by an indication receiving component 1040, as described with reference to FIG. 10.

At 1810, the method may include receiving one or more MBS messages within the geographic service area supported by the first cell and the second cell based on the synchronization information. The operations of 1810 may be performed in accordance with examples disclosed herein. In some examples, aspects of the operations of 1810 may be performed by an MBS receiver 1030, as described with reference to FIG. 10.

At 1815, the method may include decoding the one or more MBS messages based on the synchronization information. The operations of 1815 may be performed in accordance with examples disclosed herein. In some examples, aspects of the operations of 1815 may be performed by a decoding component 1055, as described with reference to FIG. 10.

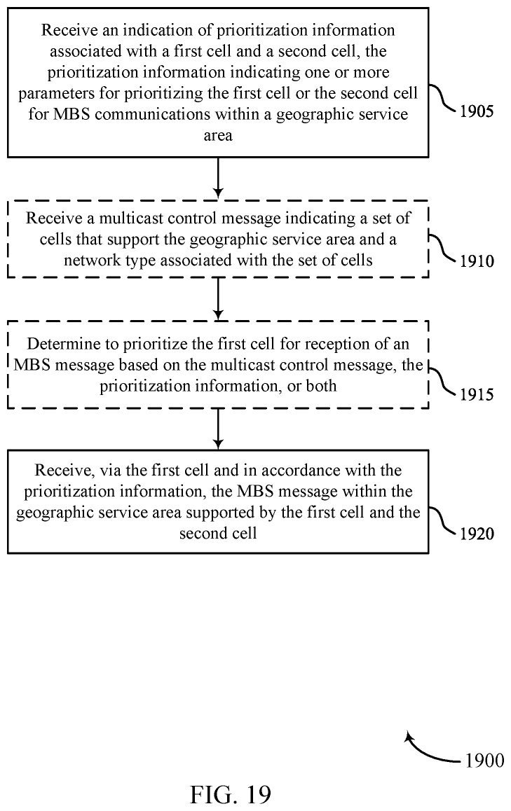

FIG. 19 shows a flowchart illustrating a method 1900 that supports broadcast communications for terrestrial and non-terrestrial cells in accordance with one or more aspects of the present disclosure. The operations of the method 1900 may be implemented by a UE or components of a UE, as described herein. For example, the operations of the method 1900 may be performed by a UE 115, as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1905, the method may include receiving an indication of prioritization information associated with a first cell and a second cell, the prioritization information indicating one or more parameters for prioritizing the first cell or the second cell for MBS communications within a geographic service area. The operations of 1905 may be performed in accordance with examples disclosed herein. In some examples, aspects of the operations of 1905 may be performed by an indication receiving component 1040, as described with reference to FIG. 10.

At 1910, the method may include receiving a multicast control message indicating a set of cells that support the geographic service area and a network type associated with the set of cells. The operations of 1910 may be performed in accordance with examples disclosed herein. In some examples, aspects of the operations of 1910 may be performed by a message receiver 1025, as described with reference to FIG. 10.

At 1915, the method may include determining to prioritize the first cell for reception of an MBS message based on the multicast control message, the prioritization information, or both. The operations of 1915 may be performed in accordance with examples disclosed herein. In some examples, aspects of the operations of 1915 may be performed by a cell prioritizing component 1060, as described with reference to FIG. 10.

At 1920, the method may include receiving, via the first cell and in accordance with the prioritization information, the MBS message within the geographic service area supported by the first cell and the second cell. The operations of 1920 may be performed in accordance with examples disclosed herein. In some examples, aspects of the operations of 1920 may be performed by an MBS receiver 1030, as described with reference to FIG. 10.

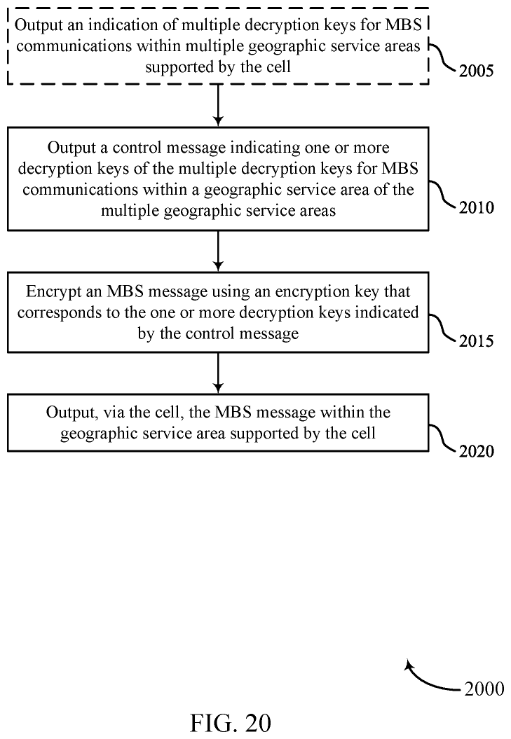

FIG. 20 shows a flowchart illustrating a method 2000 that supports broadcast communications for terrestrial and non-terrestrial cells in accordance with one or more aspects of the present disclosure. The operations of the method 2000 may be implemented by a network entity or components of a network entity, as described herein. For example, the operations of the method 2000 may be performed by a network entity 105, as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 2005, the method may include outputting an indication of multiple decryption keys for MBS communications within multiple geographic service areas supported by the cell. The operations of 2005 may be performed in accordance with examples disclosed herein. In some examples, aspects of the operations of 2005 may be performed by an indication outputting component 1440, as described with reference to FIG. 14.

At 2010, the method may include outputting a control message indicating one or more decryption keys of the multiple decryption keys for MBS communications within a geographic service area of the multiple geographic service areas. The operations of 2010 may be performed in accordance with examples disclosed herein. In some examples, aspects of the operations of 2010 may be performed by a message outputting component 1425, as described with reference to FIG. 14.

At 2015, the method may include encrypting an MBS message using an encryption key that corresponds to the one or more decryption keys indicated by the control message. The operations of 2015 may be performed in accordance with examples disclosed herein. In some examples, aspects of the operations of 2015 may be performed by an encrypting component 1430, as described with reference to FIG. 14.

At 2020, the method may include outputting, via the cell, the MBS message within the geographic service area supported by the cell. The operations of 2020 may be performed in accordance with examples disclosed herein. In some examples, aspects of the operations of 2020 may be performed by an MBS component 1435, as described with reference to FIG. 14.

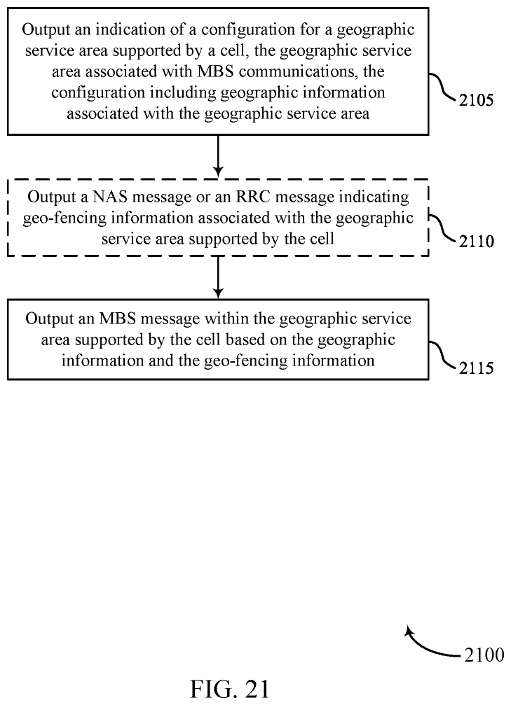

FIG. 21 shows a flowchart illustrating a method 2100 that supports broadcast communications for terrestrial and non-terrestrial cells in accordance with one or more aspects of the present disclosure. The operations of the method 2100 may be implemented by a network entity or components of a network entity, as described herein. For example, the operations of the method 2100 may be performed by a network entity 105, as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 2105, the method may include outputting an indication of a configuration for a geographic service area supported by a cell, the geographic service area associated with MBS communications, the configuration including geographic information associated with the geographic service area. The operations of 2105 may be performed in accordance with examples disclosed herein. In some examples, aspects of the operations of 2105 may be performed by an indication outputting component 1440, as described with reference to FIG. 14.

At 2110, the method may include outputting a NAS message or an RRC message indicating geo-fencing information associated with the geographic service area supported by the cell. The operations of 2110 may be performed in accordance with examples disclosed herein. In some examples, aspects of the operations of 2110 may be performed by a message outputting component 1425, as described with reference to FIG. 14.

At 2115, the method may include outputting an MBS message within the geographic service area supported by the cell based on the geographic information and the geo-fencing information. The operations of 2115 may be performed in accordance with examples disclosed herein. In some examples, aspects of the operations of 2115 may be performed by an MBS component 1435, as described with reference to FIG. 14.

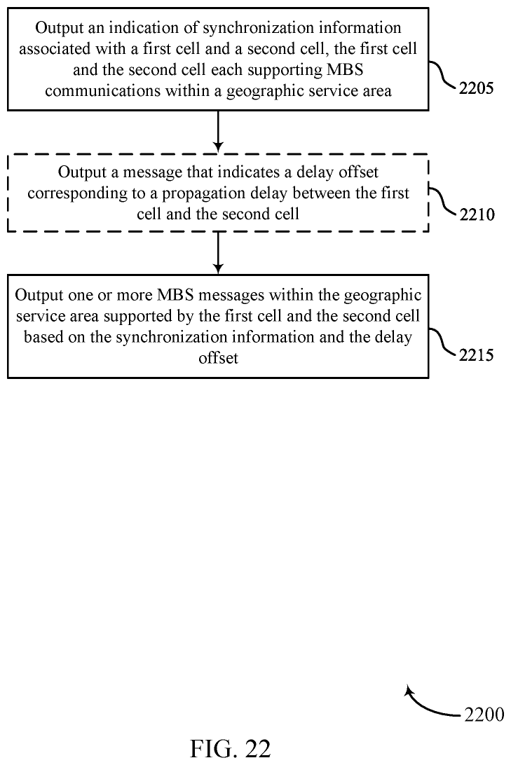

FIG. 22 shows a flowchart illustrating a method 2200 that supports broadcast communications for terrestrial and non-terrestrial cells in accordance with one or more aspects of the present disclosure. The operations of the method 2200 may be implemented by a network entity or components of a network entity, as described herein. For example, the operations of the method 2200 may be performed by a network entity 105 described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 2205, the method may include outputting an indication of synchronization information associated with a first cell and a second cell, the first cell and the second cell each supporting MBS communications within a geographic service area. The operations of 2205 may be performed in accordance with examples disclosed herein. In some examples, aspects of the operations of 2205 may be performed by an indication outputting component 1440 described with reference to FIG. 14.

At 2210, the method may include outputting a message that indicates a delay offset corresponding to a propagation delay between the first cell and the second cell. The operations of 2210 may be performed in accordance with examples disclosed herein. In some examples, aspects of the operations of 2210 may be performed by a message outputting component 1425, as described with reference to FIG. 14.

At 2215, the method may include outputting one or more MBS messages within the geographic service area supported by the first cell and the second cell based on the synchronization information and the delay offset. The operations of 2215 may be performed in accordance with examples disclosed herein. In some examples, aspects of the operations of 2215 may be performed by an MBS component 1435, as described with reference to FIG. 14.

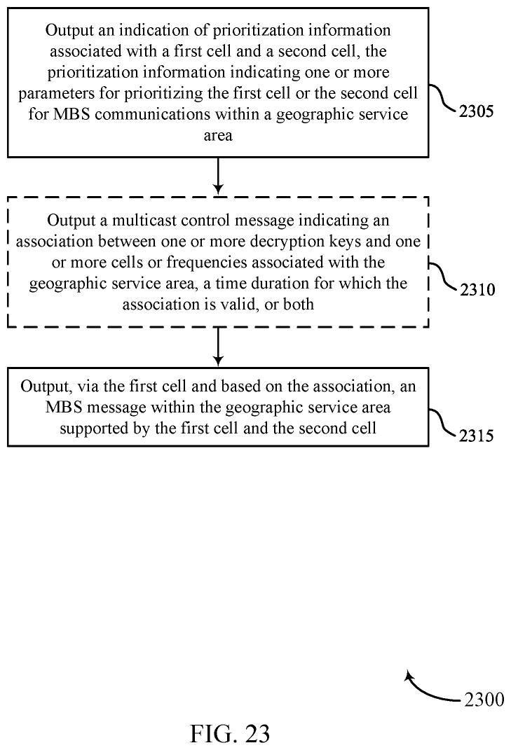

FIG. 23 shows a flowchart illustrating a method 2300 that supports broadcast communications for terrestrial and non-terrestrial cells in accordance with one or more aspects of the present disclosure. The operations of the method 2300 may be implemented by a network entity or components of a network entity, as described herein. For example, the operations of the method 2300 may be performed by a network entity 105 described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 2305, the method may include outputting an indication of prioritization information associated with a first cell and a second cell, the prioritization information indicating one or more parameters for prioritizing the first cell or the second cell for MBS communications within a geographic service area. The operations of 2305 may be performed in accordance with examples disclosed herein. In some examples, aspects of the operations of 2305 may be performed by an indication outputting component 1440 described with reference to FIG. 14.

At 2310, the method may include outputting a multicast control message indicating an association between one or more decryption keys and one or more cells or frequencies associated with the geographic service area, a time duration for which the association is valid, or both. The operations of 2310 may be performed in accordance with examples disclosed herein. In some examples, aspects of the operations of 2310 may be performed by a message outputting component 1425 described with reference to FIG. 14.

At 2315, the method may include outputting, via the first cell and based on the association, an MBS message within the geographic service area supported by the first cell and the second cell. The operations of 2315 may be performed in accordance with examples disclosed herein. In some examples, aspects of the operations of 2315 may be performed by an MBS component 1435, as described with reference to FIG. 14.

It should be noted that the methods described herein describe possible implementations, and that the operations may be rearranged or otherwise modified and that other implementations are possible. Further, aspects from two or more of the methods may be combined.

Aspect 1: A method for wireless communications at a UE, comprising: receiving a control message that indicates one or more decryption keys for MBS communications within a geographic service area supported by a cell; receiving, via the cell, an MBS message within the geographic service area supported by the cell; and decrypting the MBS message using the one or more decryption keys indicated by the control message.

Aspect 2: The method of aspect 1, further comprising: receiving an indication of a plurality of decryption keys for a plurality of geographic service areas supported by the cell; and selecting the one or more decryption keys from the plurality of decryption keys based at least in part on the geographic service area.

Aspect 3: The method of aspect 2, wherein the plurality of decryption keys comprise time-variant decryption keys that are based at least in part on a geographic location of the cell.

Aspect 4: The method of any of aspects 1 through 3, further comprising: generating the one or more decryption keys based at least in part on an identifier of the cell, an index associated with a geographic location of the UE, a beam index, a tracking area, a key value, a counter value, or a combination thereof.

Aspect 5: The method of any of aspects 1 through 4, further comprising: transmitting an indication of a geographic location of the UE, wherein receiving the control message is based at least in part on the geographic location of the UE corresponding to the geographic service area supported by the cell.

Aspect 6: The method of any of aspects 1 through 5, wherein the MBS message comprises multicast control data, multicast traffic data, or both.

Aspect 7: The method of aspect 6, wherein the multicast control data comprises an indication that the multicast traffic data is encrypted, an indication that an encryption key used for encryption of the multicast traffic data has changed within a time period, an indication of an index associated with the encryption key used for encryption of the multicast traffic data, or a combination thereof.

Aspect 8: The method of aspect 7, wherein receiving the MBS message is based at least in part on an encryption status of the multicast traffic data and on a determination that the one or more decryption keys are valid for the MBS message.

Aspect 9: The method of any of aspects 6 through 8, further comprising: receiving a paging message that indicates that an encryption key used for encryption of the multicast traffic data has changed.

Aspect 10: The method of any of aspects 6 through 9, further comprising: determining that the UE has moved to a second geographic service area that is different from the geographic service area supported by the cell; and decrypting the multicast traffic data using a decryption key that is based at least in part on a tracking area associated with the second geographic service area, an index associated with the second geographic service area, or both.

Aspect 11: A method for wireless communications at a UE, comprising: receiving an indication of a configuration for a geographic service area supported by a cell, the geographic service area associated with MBS communications, the configuration comprising geographic information associated with the geographic service area; and receiving an MBS message within the geographic service area supported by the cell based at least in part on the geographic information in the configuration.

Aspect 12: The method of aspect 11, further comprising: decrypting the MBS message using a decryption key that is based at least in part on the configuration for the geographic service area.

Aspect 13: The method of any of aspects 11 through 12, wherein receiving the indication comprises: receiving dedicated signaling or a broadcast message that indicates one or more tracking areas, cell identifiers, or frequencies associated with the geographic service area.

Aspect 14: The method of any of aspects 11 through 13, further comprising: receiving a message that indicates an association between a plurality of TACs and a plurality of tracking areas within the geographic service area supported by the cell; and performing a cell selection procedure based at least in part on the association, a tracking area of the UE, a set of cells corresponding to the tracking area of the UE, a set of frequencies corresponding to the tracking area of the UE, or a combination thereof.

Aspect 15: The method of any of aspects 11 through 14, wherein receiving the indication comprises: receiving a message that indicates a time duration for which the configuration of the geographic service area is valid, the configuration comprising a list of frequencies or cells associated with the geographic service area.

Aspect 16: The method of any of aspects 11 through 15, further comprising: performing a cell selection procedure based at least in part on a tracking area of the UE, the configuration for the geographic service area supported by the cell, and a time duration for which the configuration is valid.

Aspect 17: The method of any of aspects 11 through 16, wherein receiving the indication comprises: receiving, via a serving cell of the UE or a previous serving cell of the UE, a broadcast message that indicates a list of tracking areas associated with the geographic service area.

Aspect 18: The method of any of aspects 11 through 17, further comprising: receiving a NAS message or an RRC message that indicates geo-fencing information associated with the geographic service area supported by the cell; and performing a cell selection procedure based at least in part on the geo-fencing information, the configuration of the geographic service area, or both.

Aspect 19: A method for wireless communications at a UE, comprising: receiving an indication of synchronization information associated with a first cell and a second cell, the first cell and the second cell each supporting MBS communications within a geographic service area; and receiving one or more MBS messages within the geographic service area supported by the first cell and the second cell based at least in part on the synchronization information.

Aspect 20: The method of aspect 19, further comprising: decoding the one or more MBS messages based at least in part on the synchronization information.

Aspect 21: The method of any of aspects 19 through 20, wherein receiving the one or more MBS messages comprises: receiving the one or more MBS messages via one or both of the first cell or the second cell based at least in part on a signal quality associated with the first cell, a signal quality associated with the second cell, or both.

Aspect 22: The method of any of aspects 19 through 21, wherein receiving the one or more MBS messages comprises: receiving the one or more MBS messages via one or both of the first cell or the second cell while the UE is in a receive-only mode.

Aspect 23: The method of any of aspects 19 through 22, wherein receiving the one or more MBS messages comprises: receiving the one or more MBS messages via one or both of the first cell or the second cell based at least in part on the first cell or the second cell applying a delay offset to the one or more MBS messages.

Aspect 24: The method of aspect 23, further comprising: receiving a message that indicates the delay offset; and decoding at least a portion of the one or more MBS messages based at least in part on the delay offset, wherein one or both of the first cell or the second cell are associated with a non-terrestrial network or a terrestrial network.

Aspect 25: A method for wireless communications at a UE, comprising: receiving an indication of prioritization information associated with a first cell and a second cell, the prioritization information indicating one or more parameters for prioritization of the first cell or the second cell for MBS communications within a geographic service area; and receiving, via the first cell and in accordance with the prioritization information, an MBS message within the geographic service area supported by the first cell and the second cell.

Aspect 26: The method of aspect 25, further comprising: decrypting the MBS message using a decryption key that corresponds to the first cell.

Aspect 27: The method of any of aspects 25 through 26, wherein receiving the MBS message comprises: receiving a first portion of the MBS message via the first cell; and determining to prioritize the first cell for reception of a remaining portion of the MBS message.

Aspect 28: The method of any of aspects 25 through 27, further comprising: receiving a multicast control message that indicates a set of cells that support the geographic service area and a network type associated with the set of cells; and determining to prioritize the first cell for reception of the MBS message based at least in part on the prioritization information, information in the multicast control message including geographic area and network type, or both.

Aspect 29: The method of any of aspects 25 through 28, further comprising: receiving a multicast control message that indicates an association between one or more decryption keys and one or more cells or frequencies associated with the geographic service area, a time duration for which the association is valid, or both; and determining to prioritize the first cell or the second cell for reception of MBS communications based at least in part on the multicast control message, a capability of the UE to decode MBS communications within the geographic service area, or both.

Aspect 30: The method of any of aspects 25 through 29, wherein the first cell is associated with a non-terrestrial network and the second cell is associated with a terrestrial network.

Aspect 31: A method for wireless communications at a network entity, comprising: outputting a control message that indicates one or more decryption keys for MBS communications within a geographic service area supported by a cell; encrypting an MBS message using an encryption key that corresponds to the one or more decryption keys indicated by the control message; and outputting, via the cell, the MBS message within the geographic service area supported by the cell.

Aspect 32: The method of aspect 31, further comprising: outputting an indication of a plurality of decryption keys for a plurality of geographic service areas supported by the cell, the plurality of decryption keys comprising the one or more decryption keys indicated by the control message.

Aspect 33: The method of aspect 32, wherein the plurality of decryption keys comprise time-variant decryption keys that are based at least in part on a geographic location of the cell.

Aspect 34: The method of any of aspects 31 through 33, further comprising:

generating the one or more decryption keys based at least in part on an identifier of the cell, an index associated with a geographic location, a beam index, a tracking area, a key value, a counter value, or a combination thereof.

Aspect 35: The method of any of aspects 31 through 34, further comprising:

obtaining a first message that indicates a geographic location of a UE; and outputting a second message that indicates the one or more decryption keys for MBS communications that are applicable to the geographic location of the UE.

Aspect 36: The method of any of aspects 31 through 35, wherein the MBS message comprises multicast control data, multicast traffic data, or both.

Aspect 37: The method of aspect 36, wherein the multicast control data indicates that the multicast traffic data is encrypted.

Aspect 38: The method of any of aspects 36 through 37, wherein the multicast control data indicates that the encryption key used for encryption of the multicast traffic data has changed within a time period.

Aspect 39: The method of any of aspects 36 through 38, further comprising: outputting a paging message that indicates that the encryption key used for encryption of the multicast traffic data has changed.

Aspect 40: The method of any of aspects 36 through 39, wherein the multicast control data indicates an index associated with the encryption key used for encryption of the multicast traffic data.

Aspect 41: The method of any of aspects 31 through 40, wherein the one or more decryption keys correspond to a tracking area associated with the geographic service area, an index associated with the geographic service area, or both.

Aspect 42: A method for wireless communications at a network entity, comprising: outputting an indication of a configuration for a geographic service area supported by a cell, the geographic service area associated with MBS communications, the configuration comprising geographic information associated with the geographic service area; and outputting an MBS message within the geographic service area supported by the cell based at least in part on the geographic information in the configuration.

Aspect 43: The method of aspect 42, further comprising: encrypting the MBS message using an encryption key that is based at least in part on the configuration for the geographic service area.

Aspect 44: The method of any of aspects 42 through 43, wherein outputting the indication comprises: outputting dedicated signaling or a broadcast message that indicates one or more tracking areas, cell identifiers, or frequencies associated with the geographic service area.

Aspect 45: The method of any of aspects 42 through 44, wherein outputting the indication comprises: outputting a message that indicates an association between a plurality of TACs and a plurality of tracking areas within the geographic service area supported by the cell.

Aspect 46: The method of any of aspects 42 through 45, wherein outputting the indication comprises: outputting a message that indicates a time duration for which the configuration of the geographic service area is valid, the configuration comprising a list of frequencies or cells associated with the geographic service area.

Aspect 47: The method of any of aspects 42 through 46, wherein outputting the indication comprises: outputting a broadcast message that indicates a list of tracking areas associated with the geographic service area.

Aspect 48: The method of any of aspects 42 through 47, further comprising: outputting a NAS message or an RRC message that indicates geo-fencing information associated with the geographic service area supported by the cell.

Aspect 49: A method for wireless communications at a network entity, comprising: outputting an indication of synchronization information associated with a first cell and a second cell, the first cell and the second cell each supporting MBS communications within a geographic service area; and outputting one or more MBS messages within the geographic service area supported by the first cell and the second cell based at least in part on the synchronization information.

Aspect 50: The method of aspect 49, further comprising: encrypting the one or more MBS messages using an encryption key associated with the first cell, the second cell, the geographic service area, or a combination thereof.

Aspect 51: The method of any of aspects 49 through 50, wherein outputting the one or more MBS messages comprises: outputting the one or more MBS messages with a delay offset that corresponds to a propagation delay between the first cell and the second cell.

Aspect 52: The method of aspect 51, further comprising: outputting a message that indicates the delay offset prior to transmission of the one or more MBS messages.

Aspect 53: A method for wireless communications at a network entity, comprising: outputting an indication of prioritization information associated with a first cell and a second cell, the prioritization information indicating one or more parameters for prioritization of the first cell or the second cell for MBS communications within a geographic service area; and outputting, via the first cell, an MBS message within the geographic service area supported by the first cell and the second cell.

Aspect 54: The method of aspect 53, further comprising: encrypting the MBS message using an encryption key that corresponds to the first cell.

Aspect 55: The method of any of aspects 53 through 54, further comprising: outputting a multicast control message that indicates a set of cells that support the geographic service area and a network type associated with the set of cells.

Aspect 56: The method of any of aspects 53 through 55, further comprising: outputting a multicast control message that indicates an association between one or more decryption keys and one or more cells or frequencies associated with the geographic service area, a time duration for which the association is valid, or both.

Aspect 57: An apparatus for wireless communications at a UE, comprising: a processor; and memory coupled with the processor, the processor configured to perform a method of any of aspects 1 through 10.

Aspect 58: An apparatus for wireless communications at a UE, comprising at least one means for performing a method of any of aspects 1 through 10.

Aspect 59: A non-transitory computer-readable medium storing code for wireless communications at a UE, the code comprising instructions executable by a processor to perform a method of any of aspects 1 through 10.

Aspect 60: An apparatus for wireless communications at a UE, comprising: a processor; and memory coupled with the processor, the processor configured to perform a method of any of aspects 11 through 18.

Aspect 61: An apparatus for wireless communications at a UE, comprising at least one means for performing a method of any of aspects 11 through 18.

Aspect 62: A non-transitory computer-readable medium storing code for wireless communications at a UE, the code comprising instructions executable by a processor to perform a method of any of aspects 11 through 18.

Aspect 63: An apparatus for wireless communications at a UE, comprising: a processor; and memory coupled with the processor, the processor configured to perform a method of any of aspects 19 through 24.

Aspect 64: An apparatus for wireless communications at a UE, comprising at least one means for performing a method of any of aspects 19 through 24.

Aspect 65: A non-transitory computer-readable medium storing code for wireless communications at a UE, the code comprising instructions executable by a processor to perform a method of any of aspects 19 through 24.

Aspect 66: An apparatus for wireless communications at a UE, comprising: a processor; and memory coupled with the processor, the processor configured to perform a method of any of aspects 25 through 30.

Aspect 67: An apparatus for wireless communications at a UE, comprising at least one means for performing a method of any of aspects 25 through 30.

Aspect 68: A non-transitory computer-readable medium storing code for wireless communications at a UE, the code comprising instructions executable by a processor to perform a method of any of aspects 25 through 30.

Aspect 69: An apparatus for wireless communications at a network entity, comprising: a processor; and memory coupled with the processor, the processor configured to perform a method of any of aspects 31 through 41.

Aspect 70: An apparatus for wireless communications at a network entity, comprising at least one means for performing a method of any of aspects 31 through 41.

Aspect 71: A non-transitory computer-readable medium storing code for wireless communications at a network entity, the code comprising instructions executable by a processor to perform a method of any of aspects 31 through 41.

Aspect 72: An apparatus for wireless communications at a network entity, comprising: a processor; and memory coupled with the processor, the processor configured to perform a method of any of aspects 42 through 48.

Aspect 73: An apparatus for wireless communications at a network entity, comprising at least one means for performing a method of any of aspects 42 through 48.

Aspect 74: A non-transitory computer-readable medium storing code for wireless communications at a network entity, the code comprising instructions executable by a processor to perform a method of any of aspects 42 through 48.

Aspect 75: An apparatus for wireless communications at a network entity, comprising: a processor; and memory coupled with the processor, the processor configured to perform a method of any of aspects 49 through 52.

Aspect 76: An apparatus for wireless communications at a network entity, comprising at least one means for performing a method of any of aspects 49 through 52.

Aspect 77: A non-transitory computer-readable medium storing code for wireless communications at a network entity, the code comprising instructions executable by a processor to perform a method of any of aspects 49 through 52.

Aspect 78: An apparatus for wireless communications at a network entity, comprising: a processor; and memory coupled with the processor, the processor configured to perform a method of any of aspects 53 through 56.

Aspect 79: An apparatus for wireless communications at a network entity, comprising at least one means for performing a method of any of aspects 53 through 56.

Aspect 80: A non-transitory computer-readable medium storing code for wireless communications at a network entity, the code comprising instructions executable by a processor to perform a method of any of aspects 53 through 56.

Aspect 81: An apparatus for wireless communications at a UE, comprising:

an antenna panel; an antenna array; a processor; and memory coupled with the processor, the processor configured to perform a method of any of aspects 1 through 30.

Aspect 82: An apparatus for wireless communications at a network entity, comprising: an antenna panel; an antenna array; a processor; and memory coupled with the processor, the processor configured to perform a method of any of aspects 31 through 56.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall be construed as a reference to an open set of conditions. For example, an example operation that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions. As used herein, the terms “output” or “outputting” may be used interchangeably with the terms “transmit” or “transmitting.” Similarly, the terms “obtain” or “obtaining” may be used interchangeably with the terms “receive” or “receiving.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations rather than all the examples that may be implemented or that are within the scope of the claims. The term “example” used herein means “serving as an example, instance, or illustration,” as opposed to “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure may be applied to other examples and designs and is to be accorded the broadest scope consistent with the principles and novel features disclosed herein.

What is claimed is:

1. An apparatus for wireless communication, comprising:
a processor; and
memory coupled with the processor, the processor configured to:
receive a control message that indicates one or more decryption keys for multicast and broadcast service (MBS) communications within a geographic service area supported by a cell:
receive, via the cell, an MBS message within the geographic service area supported by the cell; and
decrypt the MBS message based at least in part on the one or more decryption keys indicated by the control message.

2. The apparatus of claim 1, wherein the processor is further configured to:
receive an indication of a plurality of decryption keys for a plurality of geographic service areas supported by the cell; and
select the one or more decryption keys from the plurality of decryption keys based at least in part on the geographic service area.

3. The apparatus of claim 2, wherein the plurality of decryption keys comprises time-variant decryption keys that are based at least in part on a geographic location of the cell.

4. The apparatus of claim 1, wherein the processor is further configured to:
generate the one or more decryption keys based at least in part on an identifier of the cell, an index associated with a geographic location of the apparatus, a beam index, a tracking area, a key value, a counter value, or a combination thereof.

5. The apparatus of claim 1, wherein the processor is further configured to:
transmit an indication of a geographic location of the apparatus, wherein the received control message is based at least in part on an association between the geographic location of the apparatus and the geographic service area supported by the cell.

6. The apparatus of claim 1, wherein the MBS message comprises multicast control data, multicast traffic data, or both.

7. The apparatus of claim 6, wherein the multicast control data comprises an indication that the multicast traffic data is encrypted, an indication that an encryption key used for encryption of the multicast traffic data has changed within a time period, an indication of an index associated with the encryption key used for encryption of the multicast traffic data, or a combination thereof.

8. The apparatus of claim 7, wherein, to receive the MBS message, the processor is configured to:
receive the MBS message based at least in part on an encryption status of the multicast traffic data and on a determination that the one or more decryption keys are valid for the MBS message.

9. The apparatus of claim 6, wherein the processor is further configured to:
receive a paging message that indicates an encryption key used for encryption of the multicast traffic data has changed.

10. The apparatus of claim 6, wherein the processor is further configured to:
determine that the apparatus has moved to a second geographic service area that is different from the geographic service area supported by the cell; and
decrypt the multicast traffic data based at least in part on a decryption key associated with a tracking area in the second geographic service area, an index associated with the second geographic service area, or both.

11. The apparatus of claim 1, further comprising:
an antenna panel, an antenna array, or both.

12. An apparatus for wireless communication, comprising:
a processor; and
memory coupled with the processor, the processor configured to:
receive an indication of a configuration for a geographic service area supported by a cell, the geographic service area associated with multicast and broadcast service (MBS) communications, wherein the configuration comprises geographic information associated with the geographic service area; and
receive an MBS message within the geographic service area supported by the cell based at least in part on the geographic information in the configuration.

13. The apparatus of claim 12, wherein the processor is further configured to:
decrypt the MBS message based at least in part on a decryption key associated with the configuration for the geographic service area.

14. The apparatus of claim 12, wherein the processor is further configured to:
receive dedicated signaling or a broadcast message that indicates one or more tracking areas, cell identifiers, or frequencies associated with the geographic service area.

15. The apparatus of claim 12, wherein the processor is further configured to:
receive a message that indicates an association between a plurality of tracking area codes (TACs) and a plurality of tracking areas within the geographic service area supported by the cell; and
perform a cell selection procedure based at least in part on the association, a tracking area of the apparatus, a set of cells associated with the tracking area of the apparatus, a set of frequencies associated with the tracking area of the apparatus, or a combination thereof.

16. The apparatus of claim 12, wherein the processor is further configured to:
receive a message that indicates a time duration for which the configuration of the geographic service area is valid, wherein the configuration comprises a list of frequencies or cells associated with the geographic service area.

17. The apparatus of claim 12, wherein the processor is further configured to:
perform a cell selection procedure based at least in part on a tracking area of the apparatus, the configuration for the geographic service area supported by the cell, and a time duration for which the configuration is valid.

18. The apparatus of claim 12, wherein the processor is further configured to:
receive, via a serving cell of the apparatus or a previous serving cell of the apparatus, a broadcast message that indicates a list of tracking areas associated with the geographic service area.

19. The apparatus of claim 12, wherein the processor is further configured to:
receive a non-access spectrum (NAS) message or a radio resource control (RRC) message that indicates geo-fencing information associated with the geographic service area supported by the cell; and
perform a cell selection procedure based at least in part on the geo-fencing information, the configuration of the geographic service area, or both.

20. An apparatus for wireless communication, comprising:
a processor; and
memory coupled with the processor, the processor configured to:
receive an indication of synchronization information associated with a first cell and a second cell, wherein the first cell and the second cell each support multicast and broadcast service (MBS) communications within a geographic service area; and
receive one or more MBS messages within the geographic service area supported by the first cell and the second cell based at least in part on the synchronization information.

21. The apparatus of claim 20, wherein, to receive the one or more MBS messages, the processor is configured to:
receive the one or more MBS messages via one or both of the first cell or the second cell based at least in part on a signal quality associated with the first cell, a signal quality associated with the second cell, or both.

22. The apparatus of claim 20, wherein, to receive the one or more MBS messages, the processor is configured to:
receive the one or more MBS messages via one or both of the first cell or the second cell while the apparatus is in a receive-only mode.

23. The apparatus of claim 20, wherein, to receive the one or more MBS messages, the processor is configured to:
receive the one or more MBS messages via one or both of the first cell or the second cell based at least in part on a delay offset applied to the one or more MBS messages by the first cell or the second cell.

24. The apparatus of claim 23, wherein the processor is further configured to:
receive a message that indicates the delay offset; and
decode at least a portion of the one or more MBS messages based at least in part on the delay offset, wherein one or both of the first cell or the second cell are associated with a non-terrestrial network or a terrestrial network.

25. An apparatus for wireless communication, comprising:
a processor; and
memory coupled with the processor, the processor configured to:
receive an indication of prioritization information associated with a first cell and a second cell, wherein the prioritization information indicates one or more parameters for prioritization of the first cell or the second cell for multicast and broadcast service (MBS) communications within a geographic service area; and
receive, via the first cell and in accordance with the prioritization information, an MBS message within the geographic service area supported by the first cell and the second cell.

26. The apparatus of claim 25, wherein the processor is further configured to:
decrypt the MBS message based at least in part on a decryption key that corresponds to the first cell.

27. The apparatus of claim 25, wherein the processor is further configured to:
receive a first portion of the MBS message via the first cell; and
determine to prioritize the first cell for reception of a remainder of the MBS message.

28. The apparatus of claim 25, wherein the processor is further configured to:
receive a multicast control message that indicates a set of cells that support the geographic service area and a network type associated with the set of cells; and
determine to prioritize the first cell for reception of the MBS message based at least in part on the prioritization information, information in the multicast control message including geographic area and network type, or both.

29. The apparatus of claim 25, wherein the processor is further configured to:
receive a multicast control message that indicates an association between one or more decryption keys and one or more cells or frequencies associated with the geographic service area, a time duration for which the association is valid, or both; and
determine to prioritize the first cell or the second cell for reception of MBS communications based at least in part on the multicast control message, a capability of the apparatus to decode MBS communications within the geographic service area, or both.

30. The apparatus of claim 25, wherein one or both of the first cell or the second cell are associated with a non-terrestrial network or a terrestrial network.
